(19) United States
(12) Patent Application Publication
(10) Pub. No.: US 2019/0116486 A1
(43) Pub. Date: Apr. 18, 2019

(54) METHOD AND APPARATUS FOR LOCATION BASED SERVICE IN 5G SYSTEM

(71) Applicant: Electronics and Telecommunications Research Institute, Daejeon (KR)

(72) Inventors: Dongmyoung KIM, Sejong-si (KR); Myung Ki SHIN, Seoul (KR); Soohwan LEE, Deajeon (KR)

(73) Assignee: Electronics and Telecommunications Research Institute, Daejeon (KR)

(21) Appl. No.: 16/161,604

(22) Filed: Oct. 16, 2018

(30) Foreign Application Priority Data
Oct. 17, 2017 (KR) 10-2017-0134853
Oct. 18, 2017 (KR) 10-2017-0135396
Nov. 24, 2017 (KR) 10-2017-0158772
Jan. 16, 2018 (KR) 10-2018-0005720
Oct. 1, 2018 (KR) 10-2018-0117204

(51) Int. Cl. H04W 8/10; H04W 64/00; H04W 4/021; H04W 68/00

(52) U.S. Cl. CPC H04W 8/10; H04W 68/005; H04W 4/021; H04W 64/003

(57) ABSTRACT

Provided is a location reporting method including sending, by an access and mobility management function (AMF) device, a location reporting control message requesting a location of a user equipment (UE) to an access network; and receiving, by the AMF device, a location report message from the access network in response to the location reporting control message. The location reporting control message may include requested location information or a reporting type.

### CROSS-REFERENCE TO RELATED APPLICATION(S)

This application claims the priority benefit of Korean Patent Application No. 10-2017-0134853 filed on Oct. 17, 2017, Korean Patent Application No. 10-2017-0135396 filed on Oct. 18, 2017, Korean Patent Application No. 10-2017-0158772 filed on Nov. 24, 2017, Korean Patent Application No. 10-2018-0005720 filed on Jan. 16, 2018, and Korean Patent Application No. 10-2018-0117204 filed on Oct. 1, 2018, in the Korean Intellectual Property Office, the disclosures of which are incorporated herein by reference for all purposes.

### BACKGROUND

### 1. Field

One or more example embodiments relate to a method and apparatus for a location based service in a 5G system.

### 2. Description of Related Art

A mobile edge computing (MEC) technique is proposed to provide a low latency data service in a user equipment (UE). The MEC technique is used to minimize a round trip time (RTT) between the UE and a server that provides a service requested by the UE. The MEC technique relates to reducing a number of routing hops between the UE and the server and to deploying a geographical location of the server to be close to the UE.

In a 5G mobile communication network, a variety of services may be provided to the UE through a 5G network technique. Accordingly, the 5G mobile communication network may support an edge computing technique to provide the further enhanced quality of service (QoS) compared to an existing network scheme.

### SUMMARY

At least one example embodiment provides a 5G core network that may propose a base station to perform a location reporting request when a user equipment (UE) is in a CM-CONNECTED state and a local area data network (LADN) service session is present within the base station.

According to an aspect of at least one example embodiment, there is provided a location reporting method performed by an access and mobility management function (AMF) device, the method including sending a location reporting control message requesting a location of a user equipment (UE) to an access network; and receiving a location report message from the access network in response to the location reporting control message. The location reporting control message includes requested location information or a reporting type.

The requested location information may be a tracking area identifier (TAI) and a cell identity (ID).

The reporting type may indicate whether the location reporting control message is to trigger a single standalone report about a current cell identity that services the UE, to start the access network to report whenever the UE changes a cell, or to request the access network to report whenever the UE moves in or out of an area of interest.

The location reporting method may further include providing information about the area of interest requested through the location reporting control message when the reporting type is to request the access network to report whenever the UE moves in or out of the area of interest.

The location reporting method may further include sending a cancel location reporting message to the access network.

The cancel location reporting message may indicate a termination of location reporting for the UE.

The cancel location reporting message may be sent in response to a request for the location reporting for a desired period of time.

When the location reporting control message is to trigger the single standalone report and the UE is in a CM-CONNECTED state with a radio resource control (RRC) inactive state, the access network may be configured to perform radio access network (RAN) paging before reporting a location to the AMF device.

When the location reporting control message is to start the access network to continuously report whenever the UE changes the cell and the UE is in a CM-CONNECTED state with an RRC inactive state, the AMF device may be configured to receive, from the access network, the location report message including a last known location of the UE with a timestamp.

The reporting type may indicate that the location reporting control message is to request the access network to report whenever the UE moves in or out of the area of interest, the AMF device is configured to receive the location report message including the location of the UE in response to the access network recognizing that the UE moves in or out of the area of interest.

According to an aspect of at least one example embodiment, there is provided a location reporting method performed by an access network, the method including receiving a location reporting control message requesting a location of a UE from an AMF device; and sending a location report message to the AMF device in response to the location reporting control message. The location reporting control message includes a requested location information or a reporting type.

The requested location information may be a TAI and a ID.

The reporting type may indicate whether the location reporting control message is to trigger a single standalone report about a current cell identity that services the UE, to start the access network to report whenever the UE changes a cell, or to request the access network to report whenever the UE moves in or out of an area of interest.

The location reporting method may further include receiving information about the area of interest requested through the location reporting control message from the AMF device when the reporting type is to request the access network to report whenever the UE moves in or out of the area of interest.

The location reporting method may further include receiving a cancel location reporting message from the AMF device.

The cancel location reporting message may indicate a termination of location reporting for the UE.

The cancel location reporting message may be sent in response to a request for the location reporting for a desired period of time.

According to an aspect of at least one example embodiment, there is provided a UE location change notification method performed by a session management function (SMF) device, the method including determining an area of interest and providing the determined area of interest to an AMF device; and receiving a new location of a UE from the AMF device based on whether the UE moves in or out of the area of interest. The area of interest is determined based on a user plane function (UPF) service area.

The SMF device may be configured to subscribe to a UE mobility event notification service provided from the AMF device, and the service subscription may be maintained during a lifetime of a protocol data unit (PDU) session.

The SMF device may relocate a UPF device, may release a PDU session, or may deactivate a user plane connection for the PDU session, in response to receiving a new location of the UE.

The SMF device may be configured to determine a new area of interest corresponding to the new location of the UE.

The SMF device may be configured to unsubscribe from the UE mobility event notification service in response to releasing the PDU session.

According to an aspect of at least one example embodiment, there is provided a UE location change notification method performed by an AMF device, the method including verifying, by the AMF device, whether a UE moves in or out of an area of interest; and notifying an SMF device of a new location of the UE. The area of interest is determined based on a UPF service area.

The SMF device may be configured to subscribe to a UE mobility event notification service provided from the AMF device. The SMF device may be configured to determine the area of interest and to provide the determined area of interest to the AMF device during the service subscription.

The service subscription may be maintained during a lifetime of a PDU session.

According to an aspect of at least one example embodiment, there is provided an AMF device including a processor; and a memory configured to store a computer-readable instruction. When the instruction is executed by the processor, the AMF device is configured to send a location reporting control message requesting a location of a UE to an access network, and to receive a location report message from the access network in response to the location reporting control message. The location reporting control message includes requested location information or a reporting type.

According to an aspect of at least one example embodiment, there is provided an access network including a processor; and a memory configured to store a computer-readable instruction. When the instruction is executed by the processor, the access network is configured to receive a location reporting control message requesting a location of a UE from an AMF device, and to send a location report message to the AMF device in response to the location reporting control message. The location reporting control message includes requested location information or a reporting type.

According to an aspect of at least one example embodiment, there is provided an SMF device including a processor; and a memory configured to store a computer-readable instruction. When the instruction is executed by the processor, the SMF device is configured to determine an area of interest and to provide the determined area of interest to an AMF device, and to receive a new location of a UE from the AMF device based on whether the UE moves in or out of the area of interest. The area of interest is determined based on a UPF service area.

According to an aspect of at least one example embodiment, there is provided an AMF device including a processor; and a memory configured to store a computer-readable instruction. When the instruction is executed by the processor, the AMF device is configured to verify whether a UE moves in or out of an area of interest, and to notify an SMF device of a new location of the UE. The area of interest is determined based on a UPF service area.

According to some example embodiments, when a UE is in a CM-CONNECTED state and a LADN service session is present within a base station, a 5G core network may propose the base station to perform a location reporting request.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 illustrates an example of a registration management (RM) state model of a user equipment (UE) according to an example embodiment;

FIG. 2 illustrates an example of an RM state model of an access and mobility management function (AMF) device according to an example embodiment;

FIG. 3 illustrates an example of a connection management (CM) state transition in a UE according to an example embodiment;

FIG. 4 illustrates an example of a CM state transition in an AMF device according to an example embodiment;

FIG. 5 illustrates an example of four cases showing a relationship between a registration area and an area of interest according to an example embodiment;

FIG. 6 illustrates an example of an N4 session establishment procedure according to an example embodiment;

FIG. 7 illustrates an example of an N4 session modification procedure according to an example embodiment;

FIG. 8 illustrates an example of an N4 session release procedure according to an example embodiment;

FIG. 9 illustrates an example of an N4 reporting procedure according to an example embodiment;

FIG. 10 illustrates an example of a change procedure of a session and service continuity (SSC) mode 2 PSA for a PDU session according to an example embodiment;

FIG. 11 illustrates an example of a change procedure of an SSC mode 3 protocol data unit (PDU) session anchor with a plurality of PDU sessions according to an example embodiment;

FIG. 12 illustrates an example of a UE configuration update procedure according to an example embodiment;

FIG. 13 illustrates an example of a UE reachability notification request procedure according to an example embodiment;

FIG. 14 illustrates an example of a UE activity procedure according to an example embodiment; and

FIG. 15 illustrates an example of a location reporting procedure according to an example embodiment.

### DETAILED DESCRIPTION

Hereinafter, some example embodiments will be described in detail with reference to the accompanying drawings. Regarding the reference numerals assigned to the elements in the drawings, it needs to be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

The following detailed structural or functional description of example embodiments is provided as an example only and various alterations and modifications may be made to the example embodiments. Accordingly, the example embodiments are not construed as being limited to the disclosure and needs to be understood to include all changes, equivalents, and replacements within the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It needs to be noted that if it is described that one component is “connected,” “coupled,” or “joined” to another component, a third component may be “connected,” “coupled,” and “joined” between the first and second components, although the first component may be directly connected, coupled, or joined to the second component. On the contrary, it needs to be noted that if it is described that one component is “directly connected,” “directly coupled,” or “directly joined” to another component, a third component may be absent. Expressions describing a relationship between components, for example, “between,” directly between,” or “directly neighboring,” etc., needs to be interpreted to be alike.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, operations, operations, elements, and/or components, but do not preclude the presence or addition of one or more other features, integers, operations, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, the example embodiments are described with reference to the accompanying drawings.

<Definitions>

5G access network: refers to an access network that includes an NG-RAN and/or non-3GPP AN connecting to a 5G core network.

5G core network: connects to the 5G access network.

5G system: refers to a 3GPP system that includes the 5G access network, the 5G core network, and a user equipment (UE).

Allowed area: refers to an area in which the UE is allowed to initiate communication.

AMF region: refers to an AMF region that includes one or more access and mobility management function (AMF) sets.

Forbidden area: refers to an area in which the UE is not allowed to initiate communication.

Initial registration: refers to UE registration in an RM-DEREGISTERED state.

Local area data network: refers to a data network (DN) that is accessible by the UE in a specific location, that provides connectivity to a specific DNN, and of which availability is provided to the UE.

Mobility pattern: refers to a network concept of determining UE mobility parameters in an

Mobility registration update: refers to a UE re-registration in response to entering a new tracking area (TA) outside a tracking area identifier (TAI) list.

NG-RAN: refers to a radio access network (RAN) that supports at least one of the following options with the common characteristics that it connects to the 5G core network: 1) standalone new radio; 2) new radio is an anchor with E-UTRA extensions; 3) standalone E-UTRA; and 4) E-UTRA is an anchor with new radio extensions.

Non-allowed area: refers to an area in which the UE is allowed to initiate a registration procedure but no other communication.

Protocol data unit (PDU) session: refers to an association between the UE and a data network that provides a PDU connectivity service.

PDU connectivity service: refers to a service that provides exchange of PDUs between the UE and the data network.

PDU session type: refers to a type of a PDU session that may be IPv4, IPv6, Ethernet, or unstructured.

Periodic registration update: refers to a UE re-registration at expiry of a periodic registration timer.

Service continuity: refers to uninterrupted user experience of a service, including a case in which an IP address and/or an anchoring point change.

Session continuity: refers to a continuity of a PDU session. For a PDU session of IPv4 or IPv6 type, “session continuity” indicates that an IP address is preserved for lifetime of the PDU session.

Uplink classifier: refers to user plane function (UPF) functionality that aims at diverting uplink traffic, based on filter rules provided from an SMF device, towards a data network.

<Abbreviations>

5GC: core network

5GS: 5G system

5G-AN: 5G access network

5G-GUTI: 5G globally unique temporary identifier

AMF: access and mobility management function

AUSF: authentication server function

CP: control plane

DL: downlink

DN: data network

DNN: data network name

HR: home routed (roaming)

LADN: local area data network

MICO: mobile initiated connection only

N3IWF: non-3GPP inter working function

NAI: network access identifier

NF: network function

NR: new radio

NEF: network exposure function

NRF: network repository function

PCF: policy control function

PSA: PDU session anchor

(R)AN: (radio) access network

SSC: session and service Continuity

SUCI: subscription concealed identifier

SUPI: subscription permanent identifier

UL: uplink

UL CL: uplink classifier

UPF: user plane function

UDR: unified data repository

In the following, each of a session management function (SMF), an access and mobility management function (AMF), and a user plane function (UPF) may be a software function, or may be installed or executed on each of multiple hardware modules.

<Concepts>

A 5G system architecture is defined to support data connectivity and services using techniques such as, for example, network function virtualization (NFV) and software defined networking (SDN). The 5G system architecture may leverage service-based interactions between control plane (CP) network functions. Some key principles and concept follow as:

i) separate user plane (UP) functions from control plane (CP) functions, allowing independent scalability, evolution, and flexible deployments, for example, a centralized location or a distributed (remote) location; ii) modularize a function design, for example, to enable flexible and efficient network slicing; iii) if applicable, define procedures (i.e., a set of interactions between network functions) as services, so their reuse is possible; iv) enable each network function to interact with other network functions directly if necessary (here, the architecture does not preclude the use of an intermediate function to help route CP messages); v) minimize dependency between the access network (AN) and the core network (CN) (here, the architecture is defined with a converged core network with a command AN-CN interface that integrates different access type)s; vi) support a unified authentication framework; vii) support “stateless” NFs in which a “compute” resource is decoupled from a “storage” resource; viii) support capability exposure; ix) support a concurrent access to local and centralized services (here, to support low latency services and an access to local data networks, UP functions may be deployed close to the access network); and x) support roaming with both home routed traffic as well as Local breakout traffic in a visited PLMN.

<Architecture Reference Model>

Here, an architecture of the 5G system is described. The 5G system architecture is defined as a service-based architecture and an interaction between network functions is represented in the following two ways:

i) A service-based representation describes that network functions, for example, an AMF device, within a control plane enable other authorized network functions to access services of the network functions. The service-based representation may include a point-to-point reference point if necessary. ii) A reference point representation describes that an interaction is present between NF services in network functions described by a point-to-point reference point, for example, N11, between any two network functions, for example, an AMF and an SMF.

<Service-Based Interface>

The 5G system architecture includes the following service-based interfaces:

i) Namf: a service-based interface exhibited by an AMF; ii) Nsmf: a service-based interface exhibited by an SMF; iii) Nnef: a service-based interface exhibited by an NEF; iv) Npcf: a service-based interface exhibited by a PCF; v) Nudm: a service-based interface exhibited by a unified data management (UDM); vi) Naf: a service-based interface exhibited by an AF; vii) Nnrf: a service-based interface exhibited by an NRF; viii) Nnssf: a service-based interface exhibited by an NSSF; ix) Nausf: a service-based interface exhibited by an AUSF; x) Nudr: a service-based interface exhibited by a unified data repository (UDR); and xi) Nudsf: a service-based interface exhibited by a UDSF.

<Reference Points>

The 5G system architecture includes the following reference points:

1) N1: a reference point between a UE and an AMF device; 2) N2: a reference point between an access network and the AMF device; 3) N3: a reference point between the access network and a UPF device; 4) N4; a reference point between an SMF device and the UPF device; 5) N6: a reference point between the UPF device and a data network; and 6) N9: reference point between UPF devices.

The following reference points describe interactions that are present between NF services in NFs. The reference points are realized by corresponding NF service-based interfaces and by specifying an identified consumer and producer NF service as well as interaction therebetween to realize a specific system procedure:

1) N5: a reference point between a PCF and an AF; 2) N7: a reference point between the SMF device and the PCF; 3) N8: a reference point between a UDM and the AMF device; 4) N10: a reference point between the UDM and the SMF device; 5) N11: a reference point between the AMF device and the SMF device; 6) N12: a reference point between the AMF device and an AUSF; and 7) N14: a reference point between AMF devices.

<Support of Non-3GPP Access>

The 5G core network supports the connectivity of the UE over the non-3GPP access networks, for example, a wireless local area network (WLAN) access. Support of non-3GPP access networks deployed outside the NG-RAN (referred to as a “standalone” non-3GPP access) is described herein.

The 5G core network may support an untrusted non-3GPP access. The non-3GPP access networks may be connected to the 5G core network over a non-3GPP interworking function (N3IWF). The N3IWF may interface 5G core network CP and UP functions through N2 and N3 interfaces, respectively.

N2 and N3 reference points may be used to connect standalone non-3GPP accesses to the 5G core network CP and UP functions, respectively.

The UE that accesses the 5G core network over the standalone non-3GPP access may, after UE attachment, support NAS signaling with the 5G core network CP functions using the N1 reference point.

When the UE is connected over the NG-RAN and over the standalone non-3GPP access, a plurality of N1 instances may be present for the UE. That is, a single N1 instance over the NG-RAN and a single N1 instance over the non-3GPP access may be present.

The UE simultaneously connected to the same 5G core network of a PLMN over the 3GPP access and the non-3GPP access may be served by a single AMF device if the selected N3IWF is located in the same PLMN as that of the 3GPP access.

When the UE is connected to the 3GPP access of the PLMN, if the UE selects the N3IWF and the N3IWF is located in a PLMN different from the PLMN of the 3GPP access, for example, in a different VPLMN or in an HPLMN, the UE may be served separately by the two PLMNs. The UE may be registered with two separate AMF devices. PDU sessions over the 3GPP access may be served by V-SMF devices different from a V-SMF device serving the PDU sessions over the non-3GPP access.

The PLMN selection for the 3GPP access does not depend on the N3IWF selection. If the UE is registered over the non-3GPP access, the UE may perform the PLMN selection for the 3GPP access independently of the PLMN to which the N3IWF belongs.

The UE may establish an IPSec tunnel with the N3IWF to attach to the 5G core network over the untrusted non-3GPP access. The UE may be authenticated by and attached to the 5G core network during the IPSec tunnel establishment procedure.

It may be possible to maintain a UE signaling connection with the AMF device over the non-3GPP access after all the PDU sessions for the UE over that access are released or handed over to the 3GPP access. N1 NAS signaling over the standalone non-3GPP accesses may be protected with the same security mechanism applied for N1 over the 3GPP access.

User plane QoS differentiation between UE and N3IWF is supported.

<Registration Management>

The registration management is used to register or deregister a UE/user with a network, and to establish a user context in the network.

The UE/user needs to register with the network to receive a service that requires registration. Once registered and if applicable, the UE updates its registration with the network 1) periodically to remain reachable (period registration update); 2) upon mobility (mobility registration update); or 3) to update its capability or re-negotiate protocol parameters.

An initial registration procedure includes execution of network access control functions (i.e., user authentication and access authorization based on subscription files in UDM). As a result of the registration procedure, an identifier of a serving AMF device serving the UE in an access through which the UE is registered may be registered in the UDM.

The registration management procedure may be applied over a 3GPP access and a non-3GPP access. 3GPP and non-3GPP registration management (RM) states are mutually independent.

The following two RM states are used in the UE and the AMF device that reflect a registration status of the UE in the selected PLMN: i) RM-DEREGISTERED and ii) RM-REGISTERED.

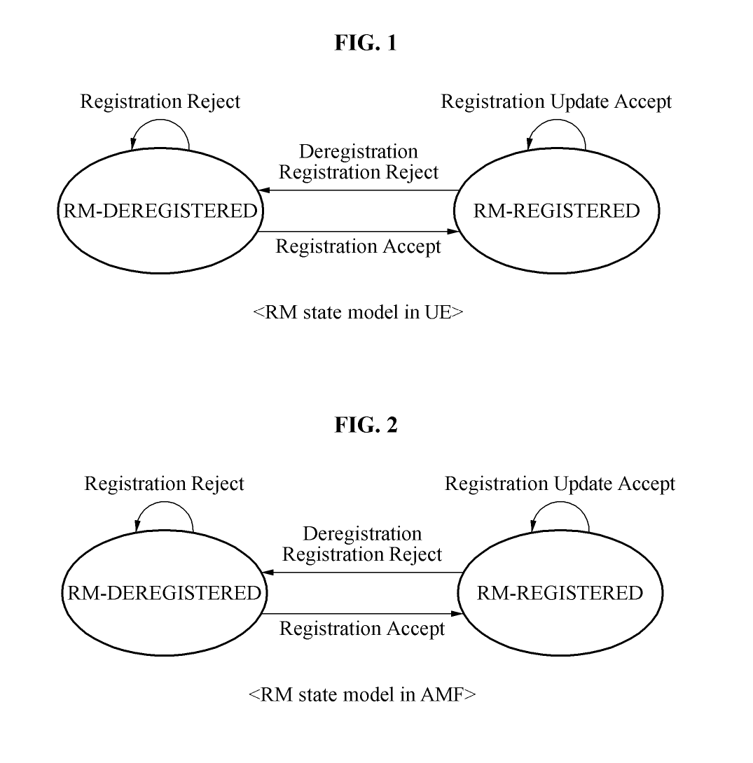

FIG. 1 illustrates an example of a registration management (RM) state model of a UE according to an example embodiment, and FIG. 2 illustrates an example of an RM state model of an AMF device according to an example embodiment.

1. RM-DEREGISTERED State

In the RM-DEREGISTERED state, the UE is not registered with a network. A UE context in an AMF device holds no valid location or routing information for the UE. Therefore, the UE may not be reachable by the AMF device. However, a portion of the UE context may be stored in the UE and the AMF device, for example, to avoid running an authentication procedure during every registration procedure.

In the RM-DEREGISTERED state, the UE may i) attempt to register with the selected PLMN using the initial registration procedure if the UE needs to receive a service that requires registration; ii) remain in the RM-DEREGISTERED state if the UE receives a registration reject upon initial registration; and iii) enter an RM-REGISTERED state in response to receiving a registration accept.

When a UE RM state of the AMF device is RM-DEREGISTERED, the AMF device may i), if applicable, accept the initial registration of the UE by sending a registration accept to the UE and enter the RM-REGISTERED state for the UE; or ii), if applicable, reject the initial registration of the UE by sending a registration reject to the UE.

2. RM-REGISTERED State

In the RM-REGISTERED state, the UE is registered with the network. In the RM-REGISTERED state, the UE may receive a service that requires registration with the network.

In the RM-REGISTERED state, the UE may i) perform a mobility registration update procedure if a current TAI of a servicing cell is absent in a list of TAIs that the UE receives from the network to maintain the registration and enable the AMF device to page the UE; ii) perform a periodic registration update procedure triggered by expiry of a periodic update timer to notify the network that the UE is still active; iii) perform a registration update procedure to update its capability information or to re-negotiate parameters with the network; iv) perform a deregistration procedure and enter the RM-DEREGISTERED state when the UE needs to be no longer registered with the PLMN (the UE may determine to deregister from the network at any time); and v) enter the RM-DEREGISTERED state in response to receiving a registration reject message or a deregistration message. The actions of the UE depend on a cause value in a registration rejection message or a deregistration message.

When the UE RM state of the AMF device is RM-REGISTERED, the AMF device may i) perform a deregistration procedure and enter the RM-DEREGISTERED state for the UE when the UE needs to be no longer registered with the PLMN (the network may determine to deregister the UE at any time); ii) perform an implicit deregistration at any time after expiry of an implicit deregistration timer, and enter the RM-DEREGISTERED state for the UE after the Implicit deregistration; and iii), if applicable, accept or reject a registration request or a service request from the UE.

3. Registration Area Management

The registration area management includes functions of allocating and reallocating a registration area to the UE. The registration area is managed per access type, for example, 3GPP access or non-3GPP access.

When the UE registers with the network over the 3GPP access, the AMF device may allocate a set of tracking areas included in a TAI list to the UE. When the AMF device allocates the registration area, that is, the set of tracking areas in the TAI list, to the UE, a variety of information (e.g., mobility pattern and allowed/non-allowed area) may be used. The AMF device having the whole PLMN as a serving area may alternatively allocate the whole PLMN (“all PLMN”) as the registration area to the UE in a MICO mode.

The 5G system may support allocating a TAI list over different 5G-radio access technologies (RATs) in a single TAI list.

When the UE registers with the network over the non-3GPP access, the registration area for the non-3GPP access corresponds to a unique reserved TAI value (i.e., a value dedicated to the non-3GPP access). Thus, there is a unique tracking area for the non-3GPP access to 5GC, which is called N3GPP TAI.

When generating the TAI list, the AMF device may include only TAIs that are applicable on the access over which the TAI list is sent.

4. Support of UE Registered Over Both 3GPP Access and Non-3GPP Access

For a given serving PLMN, there may be a single RM context for the UE for each access, for example, when the UE is consecutively or simultaneously served by the 3GPP access and by the non-3GPP access (over the N3IWF) of the same PLMN. UDM may manage separate/independent UE registration procedures for each access.

When served by the same PLMN for the 3GPP access and the non-3GPP access, the UE may be served by the same AMF device except in a temporary situation after a mobility from EPS while the UE has PDU sessions associated with the non-3GPP access.

The AMF device may associate a plurality of access-specific RM contexts for the UE with i) a 5G-GUTI that is common to both the 3GPP access and the non-3GPP access (here, the 5G-GUTI is globally unique), ii) a registration state per access type (3GPP/non-3GPP), iii) a registration area per access type (one registration area for the 3GPP access and another registration area for the non 3GPP access. Here, the registration areas for the 3GPP access and the non-3GPP access are independent), iv) a periodic registration timer for the 3GPP access, and v) a non-3GPP implicit deregistration timer.

The AMF device may not provide the periodic registration timer for the UE over the non-3GPP access. Accordingly, the UE may not need to perform a periodic registration update procedure over the non-3GPP access. Instead, during the initial registration procedure and re-registration, the UE may be provided, over the network, with a UE non-3GPP deregistration timer that starts when the UE enters a non-3GPP CM-IDLE state.

The 5G-GUTI may be assigned or re-assigned over any of the 3GPP access and the non-3GPP access. The AMF device assigns, to the UE, a single 5G-GUTI that is used over the 3GPP access and the non-3GPP access of the same PLMN or equivalent PLMN (here, it is assumed that control and user plane connectivity is present between nodes of the registered PLMN and its equivalent PLMN). The 5G-GUTI is assigned in response to a successful registration of the UE and is valid over both the 3GPP access and the non-3GPP access to the same PLMN or equivalent PLMN for the UE. Once any initial access is performed over the non-3GPP access or over the 3GPP access, the UE provides the 5G-GUTI received in response to the earlier successful registration over any access of the same PLMN or equivalent PLMN. This enables the AN to select an AMF device that maintains a UE context created at a previous registration procedure and enables the AMF device to correlate the UE request to the existing UE context.

If the UE is performing registration over a single access and intends to perform registration over another access in the same PLMN or equivalent PLMN (e.g., the 3GPP access and the selected N3IWF are located in the same PLMN), the UE may not initiate the registration over the other access until the registration procedure over the first access is completed.

When the UE is successfully registered to one access (3GPP access or non-3GPP access) and the UE registers over the other access:

i) If the second access is located in the same PLMN or equivalent PLMN (e.g., the UE is registered over the 3GPP access and selects a N3IWF located in the same PLMN), the UE may use, for the registration to the PLMN associated with the new access, the 5G-GUTI that is provided to the UE at the previous registration for the first access in the same PLMN or equivalent PLMN.

ii) If the second access is located in a PLMN different from the registered PLMN of the first access (i.e., not the registered PLMN or equivalent PLMN of the registered PLMN), (e.g., the UE is registered to the 3GPP access and selects the N3IWF located in a PLMN different from the PLMN of the 3GPP access, or the UE is registered over the non-3GPP access and registers to the 3GPP access in the PLMN different from the PLMN of the N3IWF), the UE may use, for the registration to the PLMN associated with the new access, a 5G-GUTI only if the UE holds the 5G-GUTI that is previously received from the same PLMN. However, if the UE does not have the 5G-GUTI from the PLMN to which the UE is attempting to register or from the equivalent PLMN, a SUCI may be used for the new registration.

When the UE 5G-GUTI assigned during the registration procedure over the 3GPP access (e.g., the UE registers first over the 3GPP access) is location-dependent, the same UE 5G-GUTI may be re-used over the non-3GPP access when the selected N3IWF function is in the same PLMN as that of the 3GPP access. When the UE 5G-GUTI is assigned during the registration procedure performed over the non-3GPP access (e.g., the UE registers first over the non-3GPP access), the UE 5G-GUTI may not be location-dependent, so that the UE 5G-GUTI may not be valid for a NAS procedure over the 3GPP access and, in this case, a new AMF device may be allocated during the registration procedure over the 3GPP access.

When the UE is registered first over the 3GPP access, if the UE registers to the same PLMN over the non-3GPP access, the UE may send a globally unique AMF identifier (GUAMI) obtained over the 3GPP access to the N3IWF, which uses the received GUAMI to select the same AMF device as the 3GPP access.

The deregistration request indicates whether the deregistration request applies to the 3GPP access or the non-3GPP access, or both.

If the UE is registered on both the 3GPP access and the non-3GPP access and the UE is in a CM-IDLE state over the non-3GPP access, the UE or the AMF device may initiate a deregistration procedure over the 3GPP access to deregister the UE only on the non-3GPP access. Here, all the PDU sessions associated with the non-3GPP access may be released.

If the UE is registered on both the 3GPP access and the non-3GPP access and is in the CM-IDLE state over the 3GPP access and in a CM-CONNECTED over the non-3GPP access, the UE may initiate the deregistration procedure over the non-3GPP access to deregister the UE only on the 3GPP access. Here, all the PDU sessions associated with the 3GPP access may be released.

<Connection Management>

The connection management is used to establish or release a signaling connection between the UE and the AMF device. The connection management includes a function of establishing and releasing the signaling connection between the UE and the AMF device over N1. The signaling connection is used to enable NAS signaling exchange between the UE and the core network, and includes an access network (AN) signaling connection between the UE and the AN (a radio resource control (RRC) connection over a 3GPP access or a UE-N3IWF connection over a non-3GPP access) and an N2 connection for the UE between the AN and the AMF device.

The following CM states are used to reflect a NAS signaling connection between the AMF device and the UE:

i) CM-IDLE; and ii) CM-CONNECTED.

The CM states for the 3GPP access and the non-3GPP access are mutually independent. That is, if one is in the CM-CONNECTED state, the other may be in the CM-IDLE state at the same time.

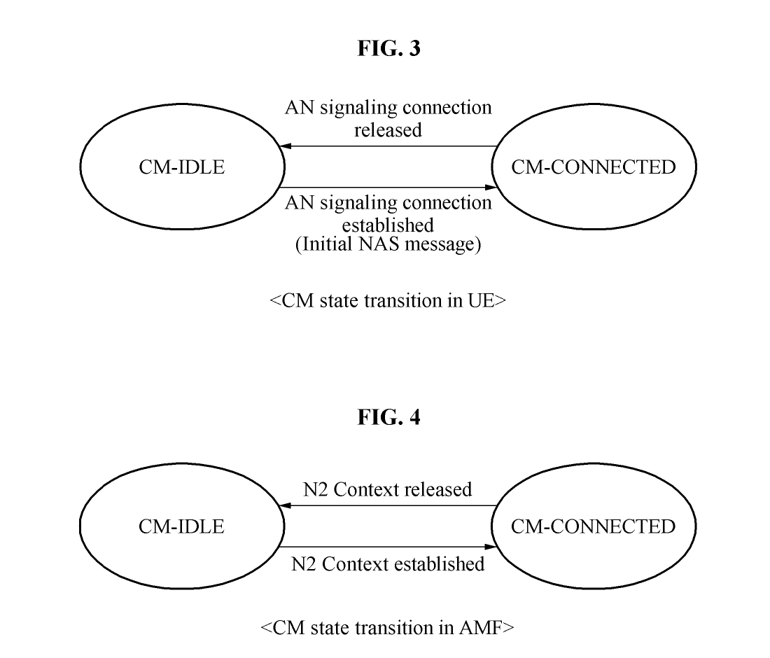

FIG. 3 illustrates an example of a connection management (CM) state transition in a UE according to an example embodiment, and FIG. 4 illustrates an example of a CM state transition in an AMF device according to an example embodiment.

CM-IDLE State

A UE in the CM-IDLE state has no signaling connection established with an AMF device over N1. The UE performs a cell selection/cell reselection and performs a PLMN selection.

The UE in the CM-IDLE state has no AN signaling connection, N2 connection, and N3 connection.

If the UE is in the CM-IDLE state and the RM-REGISTERED state, the UE may i) respond to paging by performing a service request procedure unless the UE is in a MICO mode; and ii) perform a service request procedure when the UE has uplink signaling or user data to be sent. Specific conditions are applied to LADN.

The UE may enter the CM-CONNECTED state every time an AN signaling connection is established between the UE and the AN. The UE may enter an RRC connected state over the 3GPP access or at the establishment of a UE-N3IWF connectivity over the non-3GPP access. Sending of an initial NAS message, for example, a registration request message, a service request message, or a deregistration request message, initiates a transition from the CM-IDLE state to the CM-CONNECTED state.

When the UE states in the AMF device are CM-IDLE and RM-REGISTERED, the AMF device may i) perform a network triggered service request procedure when the AMF device has signaling or mobile-terminated data to be sent to the UE by sending a paging request to the UE if the UE is not prevented from responding.

The AMF device may enter the CM-CONNECTED state for the UE every time an N2 connection is established for the UE between the AN and the AMF device.

Receiving of an initial N2 message, for example, an N2 initial UE message, initiates transition of the AMF device from the CM-IDLE state to the CM-CONNECTED state.

The UE and the AMF device may optimize the power efficiency and the signaling efficiency of the UE when the UE and the AMF device are in the CM-IDLE state.

CM-CONNECTED State

The UE in the CM-CONNECTED state has a NAS signaling connection with the AMF device over N1. The NAS signaling connection uses an RRC connection between the UE and an NG-RAN and an NGAP UE association between the AN and the AMF device. The UE may be in the CM-CONNECTED state with the NGAP UE association that is not bound to any TNLA between the AN and the AMF device. In response to completion of a NAS signaling procedure, the AMF device may determine to release the NAS signaling connection with the UE:

In the CM-CONNECTED state, the UE may i) enter the CM-IDLE state every time the AN signaling connection is released (enter an RRC idle state over the 3GPP access or when release of UE-N3IWF connectivity over the non-3GPP access is detected by the UE).

When a UE CM state in the AMF device is CM-CONNECTED, the AMF device may i) enter the CM-IDLE state for the UE every time a logical NGAP signaling connection and an N3 user plane connection for the UE are released in response to completion of the AN release procedure.

The AMF device may maintain the UE CM state in the AMF device to be in the CM-CONNECTED state until the UE deregisters from a core network.

The UE in the CM-CONNECTED state may be in an RRC inactive state. When the UE is in the RRC inactive state, the following applies i) UE reachability is managed by a RAN with assistance information from the core network; ii) UE paging is managed by the RAN; and iii) the UE monitors paging with a RAN identifier and CN (5G S-TMSI) of the UE.

3. CM-CONNECTED State with RRC Inactivate State

The RRC inactive state applies to the NG-RAN. The AMF device, based on network configuration, may provide assistance information to the NG-RAN, to assist the NG-RAN's decision regarding whether the UE may be sent to the RRC inactive state.

The “RRC inactive assistance information” includes: i) UE specific DRX values, ii) a registration area provided to the UE; iii) a periodic registration update timer, and iv) if the AMF device enables a MICO mode for the UE, an indication that the UE is in the MICO mode.

The aforementioned RRC inactive assistance information is provided from the AMF device during N2 activation with the (new) serving NG-RAN node (i.e., during registration, service request, handover) to assist the NG-RAN's decision regarding whether the UE may be sent to the RRC inactive state. The RRC inactive state is a part of RRC state machine, and it is up to the RAN to determine conditions to enter the RRC inactive state. If any of parameters included in the RRC inactive assistance information changes as a result of the NAS procedure, the AMF device may update the RRC inactive assistance information to the NG-RAN node.

When the UE is in the CM-CONNECTED state, if the AMF provides RRC inactive assistance information, the RAN node may determine to move the UE to be CM-CONNECTED with the RRC inactive state.

States of N2 and N3 reference points are not changed by the UE entering the CM-CONNECTED state with the RRC inactive state. The UE in the RRC inactive state may be aware of a RAN notification area.

The 5GC network may be unaware of UE transitions between the CM-CONNECTED state with the RRC connected state and the CM-CONNECTED with the RRC inactive state, unless the 5GC network is notified through an N2 notification procedure.

At transition to the CM-CONNECTED state with the RRC inactive state, the UE applies with periodic RAN notification area update and the timer restarts in the UE and in the RAN.

When assigning a periodic RAN notification area update timer, the NG-RAN may consider a value of the periodic registration update timer indicated in the RRC inactive assistance information.

If the periodic RAN notification area update timer expires in the RAN, the RAN may start an RRC release timer. If the RRC release timer expires, the RAN may initiate UE context release in the AN procedure.

When the UE is in the CM-CONNECTED state with the RRC inactive state, the UE may perform a PLMN selection procedure.

When the UE is in the CM-CONNECTED state with the RRC inactive state, the UE may resume the RRC connection due to: i) uplink data pending; ii) a mobile initiated NAS signaling procedure; iii) a response to RAN paging; iv) notifying the network that the UE is not in the RAN notification area; and v) expiration of the periodic RAN update timer.

If the UE resumes connection in a different NG-RAN node within the same PLMN, UE AS context is retrieved from an old NG-RAN node and a procedure is triggered towards the CN.

If a RAN paging procedure does not successfully establish contact with the UE, the RAN paging procedure may be handled by the network as follows: i) If the NG-RAN has a pending NAS PDU for transmission, the RAN node may initiate a NAS signaling connection release procedure to move the UE CM state in the AMF device to the CM-IDLE state and notify the AMF device of NAS non-delivery. ii) If the NG-RAN has pending user plane data for transmission, the NG-RAN node may maintain the N2 connection to be active or may initiate the NAS signaling connection release procedure based on local configuration of the NG-RAN.

If the UE in the CM-CONNECTED state with the RRC inactive state performs cell selection to GERAN/UTRAN/EPS, the UE may follow an idle mode procedure.

In addition, the UE in the CM-CONNECTED state with the RRC inactive state may enter the CM-IDLE mode and follow a relevant NAS procedure i) in a case in which the RRC resume procedure fails; ii) in a case in which the UE receives core network paging; and ii) in a case in which the periodic RAN notification area update timer expires and the UE may not successfully resume the RRC connection.

When the UE is in the CM-CONNECTED with the RRC inactive state, if the RAN receives a location reporting control message from the AMF device with a reporting type indicating a single standalone report, the RAN may perform RAN paging before reporting the location to the AMF device.

When the UE is in the CM-CONNECTED with the RRC inactive state, if the RAN receives the location reporting control message from the AMF device with the reporting type indicating continuously reporting whenever the UE changes a cell, the RAN may send a location report message to the AMF device including a last known location of the UE with a timestamp.

<NAS Signaling Connection Management>

The NAS signaling connection management includes functions of establishing and releasing a NAS signaling connection.

The NAS signaling connection establishment function is provided from the UE and the AMF device to establish a NAS signaling connection for the UE in the CM-IDLE state. The AMF device may provide a list of recommended cells/TAs/NG-RAN node identifiers for paging, if the NG-RAN provides information in an earlier UE context release procedure in the AN.

When the UE in the CM-IDLE state needs to send a NAS message, the UE may initiate a service request or a registration procedure to establish a signaling connection to the AMF device. Based on UE preferences, UE subscription, UE mobility pattern and network configuration, the AMF device may maintain the NAS signaling connection until the UE de-registers from the network. The procedure of releasing the NAS signaling connection is initiated by the AN node (i.e., either the 5G (R)AN node or the non-3GPP access node) or the AMF device. The NG-RAN node may include a list of recommended cells/TAs/NG-RAN node identifiers for paging, during the UE context release procedure in the AN. The AMF device stores this information, if the information is provided from the NG-RAN.

The UE verifies that the NAS signaling connection is released if the UE detects that the AN signaling connection is released. The AMF device considers that the NAS signaling connection is released in response to detecting a release of the N2 context.

<UE Mobility Restrictions>

The mobility restrictions limit mobility handling or service access of the UE in the 5G system. The mobility restriction functionality is provided from the UE, the radio access network, and the core network. The mobility restrictions only apply to the 3GPP access and do not apply to the non-3GPP access.

The mobility restrictions for a CM-IDLE state and for a CM-CONNECTED state when in an RRC inactive state are executed by the UE based on information received from the core network. The mobility restrictions for the CM-CONNECTED state when in an RRC connected state are executed by the radio access network and the core network.

In the CM-CONNECTED state, the core network provides the mobility restrictions to the radio access network within a handover restriction list.

The mobility restrictions may include i) a RAT restriction, ii) a forbidden area, iii) a service area restriction, and iv) a core network type restriction as follows:

i) RAT Restriction:

The RAFT restriction defines a 3GPP radio access technology that does not allow the UE to access a PLMN. In a restricted RAT, the UE is based on subscription not permitted to initiate any communication for the PLMN. For the CM-CONNECTED state, when the radio access network determines a target RAT and a target PLMN during a handover procedure, per PLMN RAT restriction needs to be considered.

ii) Forbidden Area:

In the forbidden area under a given RAT, the UE is based on subscription not permitted to initiate any communication with the network for the PLMN. In terms of cell selection, RAT selection, and PLMN selection, a UE behavior depends on a network response that informs the UE of the forbidden area.

iii) Service Area Restriction:

The service area restriction defines areas in which the UE may or may not initiate communication with the network as follows: \textcircled{1} allowed area: In the allowed area under a given RAT, the UE is permitted to initiate communication with the network as allowed by the subscription. \textcircled{2} non-allowed Area: In the non-allowed area under the given RAT, the UE may be service area restricted based on subscription. The UE and the network are not allowed to initiate a service request or SM signaling to obtain user services (both in the CM-IDLE state and in the CM-CONNECTED state). RRC procedures while the UE is in the CM-CONNECTED state with the RRC inactive state are unchanged compared to when the UE is in the allowed area. RM procedures are unchanged compared to when the UE is in the allowed area. The UE in the non-allowed area may respond to core network paging with the service request and RAN paging.

iv) Core Network Type Restriction:

The core network type restriction defines whether the UE is allowed to connect to the 5GC for the PLMN.

For the given UE, the core network determines the mobility restrictions based on UE subscription information, a UE location, and a UE local policy. The mobility restriction may change due to, for example, subscription, location change and local policy of the UE. Optionally, the service area restrictions or the non-allowed area may be fine-tuned by a PCF device, for example, based on UE location, PEI, and network policies. The service area restrictions may be updated during a registration procedure or a UE configuration update procedure.

If the network sends the service area restrictions to the UE, the network may send either the allowed area or the non-allowed area, and may not send both the allowed area and the non-allowed area at the same time, to the UE. If the UE receives the allowed area from the network, any TA not part of the allowed area is considered by the UE as non-allowed. If the UE receives the non-allowed area from the network, any TA not part of the non-allowed area is considered by the UE as allowed. If the UE does not receive the service area restrictions, any TA in the PLMN is considered as allowed.

If the UE has overlapping areas between RAT restrictions, forbidden areas, service area restrictions, or any combination thereof, the UE may proceed in the following precedence order:

i) An evaluation of the RAT restrictions may take precedence over an evaluation of any other mobility restrictions. ii) An evaluation of the forbidden areas may take precedence over an evaluation of the service area restrictions. iii) An evaluation of the non-allowed area may take precedence over an evaluation of allowed areas.

The UE may override the RAT restrictions, the forbidden area, and the non-allowed area restrictions whenever the UE accesses the network for regulatory prioritized services, such as emergency services and MPS. Also, the network may override the non-allowed area restrictions and the RAT restrictions for regulatory prioritized services, such as emergency services and MPS.

<Mobility Pattern>

The mobility pattern is a concept that may be used by the AMF device to characterize and optimize the UE mobility. The AMF device determines and updates the mobility pattern of the UE based on subscription of the UE, statistics of the UE mobility, a network local policy, and UE assisted information, or any combination thereof. The statistics of the UE mobility may be a historical or expected UE moving trajectory.

The UE mobility pattern may be used by the AMF device to optimize a mobility support provided to the UE, for example, a registration area allocation.

<UE Reachability in CM-IDLE State in 3GPP Access>

The reachability management functions to determine whether the UE is reachable and provide a UE location (i.e., access node) for the network to reach the UE. This functionality may be performed by paging UE and UE location tracking. The UE location tracking includes both UE registration area tracking (i.e., UE registration area update) and UE reachability tracking (i.e., UE periodic registration area update). Such functionalities may be either located at the 5GC (in the case of a CM-IDLE state) or the NG-RAN (in the case of a CM-CONNECTED state).

The UE and the AMF device negotiate UE reachability characteristics for the CM-IDLE state during registration and registration update procedures.

Two UE reachability categories are negotiated between the UE and the AMF device for the CM-IDLE state:

i) UE reachability allowing mobile terminated data while the UE is in the CM-IDLE state: \textcircled{1} The UE location may be known by the network on a tracking area list granularity. \textcircled{2} Paging procedures may apply to this category. \textcircled{3} Mobile originating and mobile terminated data may apply to this category for both the CM-CONNECTED state and the CM-IDLE state.

ii) Mobile initiated connection only (MICO) mode: \textcircled{1} Mobile originated data may apply to this category for both the CM-CONNECTED state and the CM-IDLE state. \textcircled{2} Mobile terminated data may be supported when the UE is in the CM-CONNECTED state.

Whenever the UE in the RM-REGISTERED state enters the CM-IDLE state, a periodic registration timer starts according to a periodic registration timer value received from the AMF device during the registration procedure.

The AMF device allocates the periodic registration timer value to the UE based on local policies, subscription information, and information provided from the UE. After expiry of the periodic registration timer, the UE may perform a periodic registration. If the UE moves out of network coverage in response to the expiry of the periodic registration timer, the UE may perform the registration update when the UE returns to the coverage.

The AMF device runs a mobile reachable timer for the UE. The mobile reachable timer starts with a value greater than that of the periodic registration timer of the UE whenever a CM state for the UE in the RM-REGISTERED state changes to the CM-IDLE state. If the AMF device receives an elapsed time from a RAN when the RAN initiate a UE context release indicating that the UE is unreachable, the AMF device may need to deduce a mobile reachable timer value based on the elapsed time received from the RAN and a normal mobile reachable timer value. The AMF device may stop the mobile reachable timer, if the UE CM state of the AMF device changes to the CM-CONNECTED state. If the mobile reachable timer expires, the AMF device determines that the UE is not reachable.

However, since the AMF device is unaware of a period of time in which the UE remains not reachable, the AMF device may not immediately deregister the UE. Instead, after the expiry of the mobile reachable timer, the AMF device may clear a PPF flag and may start an implicit deregistration timer with a relatively great value. The AMF device may stop the implicit deregistration timer and set the PPF flag if the UE CM state of the AMF device changes to the CM-CONNECTED state.

If the PPF flag is not set, the AMF device may not page the UE and may reject any request for delivering DL signaling or data to the UE.

If the implicit deregistration timer expires before the UE contacts the network, the AMF device may implicitly deregister the UE.

As a part of deregistration for a particular access (the 3GPP access or the non-3GPP access), the AMF device may request an SMF device related to the UE to release a PDU sessions established on the corresponding access.

<UE Reachability in CM-IDL State in 3GPP Access: UE Reachability Allowing Mobile Terminated while UE is in CM-IDLE State>

The AMF device may consider the UE in an RM-REGISTERED state to be reachable by CN paging if a UE CM state of the AMF device is a CM-IDLE state unless the UE applies a MICO mode.

<Mobile Initiated Connection Only (MICO) Mode>

The UE may represent preference for the MICO mode during initial registration or registration update. The AMF device, based on local configuration, a communication pattern if available, UE indicated preferences, UE subscription information and network policies, or any combination thereof, determines whether the MICO mode is allowed for the UE and indicates it to the UE during the registration procedure.

The UE and the core network re-initiate or terminate the MICO mode at subsequent registration signaling. If the MICO mode is not indicated explicitly in the registration procedure and the registration procedure is successful, both the UE and the AMF device may not use the MICO mode. That is, the UE may act as a normal UE and the network may treat the UE as a normal UE.

The AMF device assigns a registration area to the UE during the registration procedure. When the AMF device indicates the MICO mode to the UE, the registration area is not constrained by a paging area size. If the AMF serving area is the whole PLMN based on the local policy and subscription information, the AMF device may determine to provide an “all PLMN” registration area to the UE. In this case, re-registration to the same PLMN due to mobility does not apply.

If mobility restrictions are applied to the UE in the MICO mode, the AMF device may need to allocate an allowed area/non-allowed area to the UE.

When the AMF device indicates the MICO mode to the UE, the AMF device regards that the UE is always unreachable while the UE CM state in the AMF device is the CM-IDLE state. The AMF device rejects any request for downlink data delivery for the UE in the MICO mode and of which the UE CM state in the AMF device is the CM-IDLE state with an appropriate cause. The AMF device also defers downlink transport over NAS for SMS, location services, etc. The UE in the MICO mode may be only reachable for mobile terminated data or signaling when the UE is in the CM-CONNECTED state.

The UE in the MICO mode may not need to listen to paging while being in the CM-IDLE state. The UE in the MICO mode may stop any access stratum procedures in the CM-IDLE state, until the UE initiates transition from the CM-IDLE state to the CM-CONNECTED state due to one of the following triggers: i) A change in the UE (e.g., change in configuration) requires update its registration with the network. ii) The periodic registration timer expires. iii) MO data is pending. iv) MO signaling is pending (e.g., the SM procedure is initiated).

If a registration area that is not the “all PLMN” registration area is allocated to the UE in the MICO mode, the UE determines whether the UE is present within the registration area when the UE has MO data or MO signaling.

<UE Reachability in CM-CONNECTED State in 3GPP Access>

For the UE in the CM-CONNECTED state, i) the AMF device is aware of a location of the UE on a serving (R)AN node granularity and ii) the NG-RAN notifies the AMF device when the UE becomes unreachable from the (R)AN point of view.

UE RAN reachability management is used by the RAN for UEs in the RRC inactive state. A location of a UE in the RRC inactive state is known by the RAN on a RAN notification area granularity. The UE in the RRC inactive state is paged in cells of the RAN notification area that is assigned to the UEs. The RAN notification area may be a subset of cells configured in the registration area of the UE or all cells configured in the registration area of the UE. The UE in the RRC inactive state performs paging area update when entering a cell that is not a part of the RAN notification area that is assigned to the UE.

At transition to the RRC inactive state RAN configures the UE with a periodic RAN notification area update timer value and the timer is restarted in the UE and in the RAN with this initial timer value. After the expiry of the periodic RAN notification area update timer in the UE, the UE in the RRC inactive state performs periodic RAN notification area update.

To assist the UE reachability management in the AMF device, upon the expiry of the periodic RAN notification area update timer in the RAN, the RAN may start an RRC release timer. If the RRC release timer expires, the RAN may initiate the UE context release in the AN procedure.

<Paging Strategy Handling in 3GPP Access>

Based on an operator configuration, the 5GS supports the AMF device and the NG-RAN to apply different paging strategies for different types of traffic.

In the case of the UE in a CM-IDLE state, the AMF device performs paging and determines the paging strategy based on, for example, a local configuration that causes an NF to trigger the paging and information available in the request that triggers the paging.

In the case of the UE in a CM-CONNECTED state with an RRC inactive state, the NG-RAN performs paging and determines the paging strategy based on, for example, a local configuration and information received from the AMF device and the SMF device.

In the case of a network triggered service request from the SMF device, the SMF device determines 5QI and ARP based on downlink data or a notification of downlink data received from a UPF device. The SMF device includes 5QI and ARP corresponding to a received downlink PDU in the request that is sent to the AMF device. If the UE is in the CM IDLE state, the AMF device may use, for example, the 5QI and ARP to derive different paging strategies.

<Paging Policy Differentiation in 3GPP Access>

Paging policy differentiation (PPD) refers to an optional feature that allows the AMF device, based on an operator configuration, to apply different paging strategies for different traffic or service types provided within the same PDU session. This feature may apply only to a PDU session of an IP type.

When the 5GS supports the paging policy differentiation (PPD) feature, a DSCP value (TOS in IPv4/TC in IPv6) may be set by an application to inform the 5GS of a paging policy that needs to be applied for a specific IP packet.

The operator may configure the SMF device in such a way that the PPD feature only applies to specific HPLMNs, DNNs, and 5QIs. In the case of HR roaming, this configuration may be performed by the SMF device in a VPLMN.

In the case of the network triggered service request and a UPF buffering downlink data packet, the UPF device may include the DSCP in a TOS (IPv4)/TC (IPv6) value from an IP header of the downlink data packet and an indication of a corresponding QoS flow in a data notification message sent to the SMF device.

When the PPD applies, the SMF device determines a paging policy indicator (PPI) based on information received from the UPF device. In the case of the network triggered service request and a SMF buffering downlink data packet, when the PPD applies, the SMF device determines the PPI based on the DSCP in a TOS (IPv4)/TC (IPv6) value from an IP header of the received downlink data packet and an indication of the corresponding QoS flow. The SMF device includes the PPI, the ARP and the 5QI in an N11 message sent to the AMF device. If the UE is in the CM IDLE state, the AMF device uses this information to derive a paging strategy and sends paging messages to the NG-RAN over N2. The paging messages sent to NG-RAN may include the PPI.

The SMF device configures the UPF device to put in different QoS flow traffic with different paging differentiation requirements and may indicate over N2 to the NG-RAN the paging policy indicator (PPI) for a QoS flow (QFI) of a PDU session. For the UE in the RRC inactive state, the NG-RAN may, based on 5QI, ARP and this PPI associated with the QFI of an incoming DL PDU enforce specific paging policies applied in the case of NG-RAN paging.

<Paging Priority in 3GPP Access>

The paging priority is a feature that allows the AMF device to include an indication in a paging message sent to the NG-RAN that the UE may be paged with priority. The AMF device determines whether to include the paging priority in the paging message based on an ARP value in the message received from the SMF device for an IP packet waiting to be delivered in the UPF device. If the ARP value is associated with select priority services (e.g., MPS, MCS), the AMF device includes the paging priority in the paging message. When the NG-RAN receives the paging message with the paging priority, the NG-RAN handles the page with priority.

While waiting for the UE to respond to paging sent without priority, the AMF device receives another message from the SMF device with an ARP associated with select priority services (e.g., MPS, MCS) and the AMF device sends another paging message to the (R)AN including the paging priority.

For the UE in the RRC inactive state, the NG-RAN determines the paging priority based on the ARP associated with the QoS flow as provisioned by the operator policy and the core network assisted RAN paging information from the AMF device.

<Registration Management in Non-3GPP Access>

The UE may enter a RM-DEREGISTERED state and the AMF device may enter the RM-DEREGISTERED state for the UE over the non-3GPP access as follows:

i) at the UE and at the AMF device, after performing an explicit deregistration procedure; ii) at the AMF device, after the network non-3GPP implicit deregistration timer expires; or iii) at the UE, after the UE non-3GPP deregistration timer expires.

Whenever the UE registered over the non-3GPP access enters a CM-IDLE state for the non-3GPP access, the UE starts the UE non-3GPP deregistration timer according to a value received from the AMF device during a registration procedure.

Over the non-3GPP access, the AMF device runs the network non-3GPP implicit deregistration timer. The network non-3GPP implicit deregistration timer is initiated with a value greater than the non-3GPP deregistration timer of the UE, whenever the CM state for the UE registered over the non-3GPP access changes to the CM-IDLE state for the non-3GPP access.

For the UE that is registered over the non-3GPP access, a change of a point of attachment (e.g., a change of a WLAN AP) may not lead the UE to perform a registration update procedure.

The UE may not provide 3GPP-specific parameters (e.g., indication of a preference for a MICO mode) during registration over the non-3GPP access.

<Connection Management in Non-3GPP Access>

A UE that successfully establishes an NWu connection over an untrusted non-3GPP access transitions to a CM-CONNECTED state for the untrusted non-3GPP access.

In the case of the untrusted non-3GPP access to the 5GC, NWu signaling is released either as a result of an explicit deregistration procedure or an AN release procedure. In addition, the N3IWF may explicitly release the NWu signaling connection due to an NWu connection failure. The release of the NWu signaling connection between the UE and the N3IWF may be interpreted as follows:

i) By the N3IWF as a criterion to release an N2 connection.

ii) By the UE as a criterion for the UE to transition to a CM-IDLE state. The UE registered over the non-3GPP access remains in an RM-REGISTERED state, unless the NWu connection release occurs as part of a deregistration procedure over the non-3GPP access in which case the UE enters a RM-DEREGISTERED state. When the UE in the RM-REGISTERED state transitions to the CM-IDLE state, the UE non-3GPP deregistration timer starts running in the UE. The UE non-3GPP deregistration timer stops when the UE moves to the CM-CONNECTED state or to the RM-DEREGISTERED state.

In the case of the untrusted non-3GPP access, when the AMF device releases an N2 interface, the N3IWF may release all the resources associated with the UE including the NWu connection with the UE. The release of the N2 connection by the AMF device may set the CM state for the UE in the AMF device to be the CM-IDLE state.

The UE may not be paged on the untrusted non-3GPP access.

When the UE registered simultaneously over the 3GPP access and the non-3GPP access moves all the PDU sessions to one of the accesses, whether the UE initiates a deregistration procedure in an access that has no PDU sessions is up to the UE implementation.

Release of PDU sessions over the non-3GPP access does not indicate the release of the N2 connection.

When the UE has PDU sessions routed over the non-3GPP access and the UE enters the CM-IDLE state for the non-3GPP access, these PDU sessions are not released to enable the UE to move the PDU sessions over the 3GPP access based on UE policies. The core network maintains the PDU sessions but deactivates an N3 user plane connection for such PDU sessions.

<UE Reachability in CM-IDLE State in Non-3GPP Access>

The UE may not be paged over the untrusted non-3GPP access.

If states of the UE in the AMF device correspond to a CM-IDLE state and an RM-REGISTERED state for the non-3GPP access, there may be PDU sessions that are last routed over the non-3GPP access and without user plane resources. If the AMF device receives a data notification with a non-3GPP access type indication from the SMF device for a PDU session corresponding to the UE that is in the CM-IDLE state for the non-3GPP access, and the UE is registered over the 3GPP access in the same PLMN as one registered over the non-3GPP access, a network triggered service request may be performed over the 3GPP access independently of whether the UE is in the CM-IDLE state or a CM-CONNECTED state over the 3GPP access. In this case, the AMF device provides an indication that the procedure relates to pending downlink data for the non-3GPP access. If the UE is in the CM-IDLE state over the 3GPP access, the AMF device does not include a PDU session ID of a specific PDU session for which access type is set to the non-3GPP access.

<UE Reachability in CM-CONNECTED in Non-3GPP Access>

For the UE in a CM-CONNECTED state, i) the AMF device is aware of a UE location on a N3IWF node granularity, and ii) the N3IWF releases an N2 connection when the UE becomes unreachable from an N3IWF point of view, i.e., in response to NWu release.

<Session Management>

A 5G core network supports a PDU connectivity service. The PDU connectivity service is supported through PDU sessions that are established in response to a request from the UE.

Subscription information may include a plurality of data network names (DNNs) and a default DNN. The UE is assigned to the default DNN if a valid DNN is not provided in a PDU session establishment request sent to the 5G core network.

Each PDU session supports a single PDU session type. That is, each PDU session supports exchange of a single type of a PDU session requested by the UE at the establishment of the PDU session.

The PDU session may be established in response to a request from the UE, modified response to a request from the UE and the 5GC, and released in response to a request from the UE and the 5GC using NAS SM signaling exchanged over N1 between the UE and the SMF device. In response to a request from an application server, the 5GC may trigger a specific application in the UE. In response to receiving that trigger message, the UE may transfer the received message to an application identified in the UE. The identified application may establish a PDU session with respect to a specific DNN.

The SMF device may support a PDU session for a LADN in which an access to a data network is available in a specific LADN service area.

The SMF device may verify whether a UE request is compliant with a user subscription. For this purpose, the SMF device may retrieve and request update notifications on SMF device level subscription data from a UDM. Such data may indicate the following per DNN and, if applicable, per single network slice selection assistance information (S-NSSAI) i) allowed PDU session types and a default PDU session type; ii) allowed SSC modes and a default SSC mode; iii) QoS information, such as subscribed session-AMBR, default 5QI and default allocation and retention priority (ARP); and iv) a static IP address/prefix.

The UE that is registered over multiple accesses selects an access used to establish a corresponding PDU session. An HPLMN may send a policy to the UE to guide the UE selection of the access over which to establish the corresponding PDU session.

The UE may request to move a PDU session between the 3GPP access and the non-3GPP access. A determination to move the PDU session between the 3GPP access and the non-3GPP access is made based on a PDU session unit. That is, the UE may have some PDU sessions using the 3GPP access at a given time, while other PDU sessions are using the non-3GPP access.

In a PDU session establishment request sent to the network, the UE may provide a PDU session identifier (ID). The PDU session ID is unique per UE and is used to uniquely identify a single PDU session from among PDU sessions of the UE. The PDU session ID may be stored in the UDM to support a handover between the 3GPP access and the non-3GPP access. The UE may also provide i) a PDU session type; ii) S-NSSAI; iii) a DNN; and iv) an SSC mode.

The UE may establish a plurality of PDU sessions in the same data network or different data networks, through 3GPP and non-3GPP access networks at the same time.

The UE may establish the plurality of PDU sessions in the same data network and may be served by a different UPF device that terminates N6.

The UE with the established plurality of PDU sessions may be served by a different SMF device.

The SMF device may be registered and deregistered based on a unit of a PDU session granularity in the UDM.

User plane paths of different PDU sessions (to the same or to different DNNs) belonging to the same UE may be completely disjointed between the AN and the UPF device interfacing with the DN.

<Session Management: Interaction Between AMF Device and SMF Device>

The AMF device and the SMF device are separate network functions.

N1 related interaction with the SMF device is as follows:

i) A single N1 termination point is located in the AMF device. The AMF device forwards SM related NAS information to the SMF device based on a PDU session ID of a NAS message. Also, SM NAS exchanges (e.g., SM NAS message responses) for N1 NAS signaling received by the AMF device over an access (e.g., the 3GPP access or the non-3GPP access) are transported over the same access. ii) A serving PLMN ensures that subsequent SM NAS exchanges (e.g., SM NAS message responses) for N1 NAS signaling received by the AMF device over an access (e.g., the 3GPP access or the non-3GPP access) are transported over the same access. iii) The SMF device handles a session management part of NAS signaling exchanged with the UE. iv) The UE may initiate a PDU session establishment in an RM-REGISTERED state. v) In response to the SMF device being selected to serve a specific PDU session, the AMF device needs to ensure that all NAS signaling related within the specific PDU session is handled by the same SMF device instance. vi) In response to a successful PDU session establishment, the AMF device and the SMF device store an access type with which the PDU session is associated.

N11 related interaction with the SMF device is as follows:

i) The AMF device reports a reachability of the UE based on a subscription from the SMF device, including UE location information with respect to an area of interest indicated by the SMF device. ii) The SMF device indicates to the AMF device when a PDU session is released; iii) In response to a successful PDU session establishment, the AMF device stores an identifier of a serving SMF device of the UE and the SMF device stores an identifier of a serving AMF device of the UE including an AMF device set. When attempting to reach the AMF device serving the UE, the SMF device may need to apply a behavior described in “the other CP NFs.”

N2 related interaction with the SMF device is as follows:

i) Some N2 signaling (e.g., handover related signaling) may require an action of the AMF device and the SMF device. In this case, the AMF device needs to ensure coordination between the AMF device and the SMF device. The AMF device may forward SM N2 signaling towards the corresponding SMF device based on the PDU session ID in N2 signaling. ii) The SMF device may provide the PDU session type and the PDU session ID to NG-RAN to facilitate the NG-RAN to apply a suitable header compression mechanism to a packet of a different PDU type.

N3 related interaction with the SMF device is as follows:

i) Selective activation and deactivation of UP connection of an existing PDU session is defined.

N4 related interaction with the SMF device is as follows:

i) When the UPF device is aware of arrival of some DL data for the UE without downlink N3 tunnel information, the SMF device interacts with the AMF device to initiate Network triggered service request procedure. In this case, if the SMF device is aware that the UE is unreachable or if the UE is reachable only for a regulatory prioritized service and the PDU session is not for the regulatory prioritized service, the SMF device does not inform DL data notification to the AMF device.

The AMF device may select the SMF device per procedure. For this purpose, the AMF device may acquire subscription data from the UDM. Also, the AMF device may retrieve the subscribed UE-AMBR from the UDM and may send the retrieved UE-AMBR to the (R)AN.

The interaction between the AMF device and the SMF device to support the LADN is defined as follows:

To support charging data collection and to fulfill regulatory requirements (to provide network provided location information (NPLI)) related with set-up, modification, and release of IMS voice calls or with SMS device transfer, the following applies:

i) At the time of PDU session establishment, the AMF device provides the SMF device with a PEI of the UE if the PEI is available at the AMF device; Alternatively, ii) when forwarding UL NAS or N2 signaling to a peer NF (e.g., to the SMF device or SMSF) or during UP connection activation of a PDU session, the AMF device provides user location information received from the 5G-AN, an access type (3GPP or non-3GPP) of the AN over which the UL NAS or N2 signaling is received, and a corresponding UE time zone.

The user location information, the access type, and the UE time zone may be further provided from the SMF device to the PCF device. The PCF device may acquire information from the SMF device to provide NPLI to an application (e.g., IMS) that requests the information.

The user location information may correspond to the following:

i) In the case of NG-RAN: Cell-Id. ii) In the case of N3IWF: UE local IP address (used to reach the N3IWF) and optionally UDP or TCP source port number (if NAT is detected).

<Session Management: Support for Local Area Data Network (LADN)>

An access to a DN through a PDU session for a LADN is only available in a specific LADN service area. A LADN service area is a set of tracking areas (TAs). 5GC may support UEs to be aware of availability of the LADN based on a UE location.

For LADNs, the AMF device provides the UE with LADN information about LADN availability, and the AMF device tracks and informs the SMF device whether the UE is located in the LADN service area (i.e., an area of availability of the LADN).

The LADN information is configured in the AMF device on a per DN basis, that is, for different UEs accessing the same LADN. The configured LADN service area is the same regardless of other factors (e.g., registration area of the UE).

LADN information provided to the UE by the AMF device includes LADN DNN and LADN service area information that is available to the UE. The LADN service area information provided to the UE during the registration procedure includes a set of tracking areas that belong to a current registration area of the UE (i.e., an intersection between the LADN service area and a current registration area). The AMF device may not create the registration area based on the availability of LADNs.

When the UE performs a successful (re)registration procedure, the AMF device may provide the UE with LADN information about LADNs that are available to the UE in the RA in a registration response accept message, based on local configuration information about LADN information, UE location, UE subscription information that is received from UDM about LADN DNNs subscribed to by the UE, or policies provided from the PCF device.

When LADN information for the UE in the 5GC is changed, the AMF device may update the LADN information to the UE through the UE configuration update procedure.

Based on LADN availability information in the UE, the UE may request a PDU session establishment for an available LADN when the UE is located in the LADN service area. The UE may not request the PDU session for the LADN when the UE is located outside the LADN service area, and the SMF device may reject any such requests. The UE may not trigger a service request for establishment of user plane for an LADN PDU session when the UE is located outside the LADN service area, and the SMF device may reject the establishment of user plane for the LADN PDU session.

The SMF device may subscribe to “UE location notification”. Based on UE location information that is received from the AMF device, the SMF device may determine: i) whether the network triggered service request needs to be triggered for a LADN PDU session of which user plane connection is deactivated; ii) to release the PDU session, or iii) to deactivate the user plane connection for the PDU session and maintain the PDU session. The network may release the PDU session later at any time based on network policies. The SMF device may also request the UPF device to discard downlink data for the PDU sessions and/or not send a data notification message to the SMF device.

This decision may be influenced by local policies.

After the UE is paged and the UE triggers a service request procedure, if the SMF device determines that the UE is located outside the LADN the service area based on a most recent UE location received from the AMF device, the SMF device may reject the establishment of user plane for the LADN PDU session.

When leaving the LADN service area, the UE may have no need to release the LADN PDU session, unless the UE receives an explicit PDU session release request from the network.

The SMF device may not trigger user plane re-establishment for a PDU session corresponding to an LADN if the SMF device is aware that the UE is outside the area of availability of the LADN.

When the AMF device detects that the UE has returned to the LADN service area, the AMF device informs the SMF device of the event based on SMF subscription to an area of interest corresponding to the LADN. If the SMF device or the UPF device has pending DL data, the SMF device performs a network triggered service request to establish the user plane(s) for PDU sessions. Otherwise, the SMF device may inform the UPF device to resume sending DL data notifications to the SMF device in the case of DL data.

In this release, LADNs apply only to 3GPP accesses.

<Session Management: Selective Activation and Deactivation of UP Connection of Existing PDU Session>

This applies to a case in which the UE establishes a plurality of PDU sessions. An activation of a UP connection of an existing PDU session may cause an activation of its UE-CN user plane connection (i.e., a data radio bearer and an N3 tunnel).

For the UE in a CM-IDLE state in the 3GPP access, either the UE or network triggered service request procedure may support an independent activation of UP connection of existing PDU sessions. For the UE in the CM-IDLE state in the non-3GPP access, the UE triggered service request procedure may allow a re-activation of UP connection of existing PDU sessions and may support the independent activation of UP connection of existing PDU sessions.

The UE in a CM-CONNECTED state may invoke a service request procedure to request the independent activation of the UP connection of existing PDU sessions.

Network triggered re-activation of UP connection of existing PDU sessions is handled as follows:

i) If the UE CM state in the AMF device is already CM-CONNECTED on an access (e.g., the 3GPP access, the non-3GPP access) associated with a PDU session in the SMF device, the network may re-activate the UP connection of the PDU session using the network triggered service request procedure.

Otherwise:

ii) If the UE is registered in both the 3GPP access and the non-3GPP accesses and the UE CM state in the AMF device is CM-IDLE in the non-3GPP access, the UE may be paged or notified through the 3GPP access for the PDU session associated with the 3GPP access or with the non-3GPP access in the SMF device: \textcircled{1} If the UE CM state in the AMF device is CM-IDLE in the 3GPP access, a paging message may include an access type associated with the PDU session in the SMF device. In response to receiving the paging message including the access type, the UE may reply to the 5GC over the 3GPP access using a NAS service request message, which may include a list of PDU sessions associated with the received access type and of which UP connections may be re-activated over the 3GPP access (i.e., the list of PDU session does not include the PDU sessions of which UP connections may not be re-activated on the 3GPP access based on UE policies). If a PDU session for which the UE is paged is included in the list of PDU sessions provided in the NAS service request, the 5GC may re-activate a PDU session UP connection over the 3GPP access. \textcircled{2} If the UE CM state in the AMF device is CM-CONNECTED in the 3GPP access, a notification message may include a PDU session ID. In response to receiving the notification message, the UE may reply to the 5GC over the 3GPP access using the NAS service request message, which may include an indication on whether the PDU session UP connection may be re-activated over the 3GPP access.

ii) If the UE is registered in both the 3GPP access and the non-3GPP access served by the same AMF device and the UE CM state in the AMF device is CM-IDLE in the 3GPP access and is CM-CONNECTED in the non 3GPP access, the UE may be notified through the non-3GPP access for a PDU session associated in the SMF device (i.e., last routed) with the 3GPP access. The notification message includes the PDU session ID. In response to receiving the notification message, the UE may reply to the 5GC over the 3GPP access using the NAS service request message when the 3GPP access is available.

A deactivation of UP connection of an existing PDU session causes the corresponding data radio bearer and N3 tunnel to be deactivated. The UP connection of different PDU sessions may be deactivated independently when the UE is in the CM-CONNECTED state in the 3GPP access or the non-3GPP access.

<Session Management: Session and Service Continuity (SSC)>

Support for session and service continuity (SSC) in the 5G system architecture may address various continuity requirements of different applications and services for the UE. The 5G system supports different SSC modes. An SSC mode associated with the PDU session does not change during the lifetime of the PDU session.

i) In SSC mode 1, the network preserves a continuity service provided to the UE. In the PDU session of IPv4 or IPv6 type, an IP address may be preserved. ii) In SSC mode 2, the network may release the connectivity service delivered to the UE and may release the PDU session corresponding to the connectivity service. In the IPv4 or IPv6 type, the network may release IP addresses allocated to the UE. iii) In SSC mode 3, a change to the user plane may be visible to the UE, while the network ensures that no loss of connectivity occurs in the UE. A connection through a new PDU session anchor point may be established before a previous connection is terminated for a better service connectivity. In the IPv4 or IPv6 type, the IP address may not be preserved in the SSC mode 3 when the PDU session anchor changes.

An addition process or a removal process of a PDU session anchor in a PDU session for local access to a DN may be independent from an SSC mode of the PDU session.

<SSC Mode>

(1) SSC Mode 1

With respect to a PDU session of SSC mode 1, the UPF device acting as the PDU session anchor at establishment of the PDU session may be maintained regardless of access technology (e.g., access type and cells) for the UE to a successful network access.

In the PDU session of the IPv4 or IPv6 type, IP continuity may be supported regardless of a UE mobility event.

Here, when IPv6 multi-homing or a UL CL applies to the PDU session of SSC mode 1 and the network allocates additional PDU session anchors to the PDU session, the additional PDU session anchors may be released or allocated. The UE does not expect that an additional IPv6 prefix is maintained during the lifetime of the PDU session. SSC mode 1 may apply to any PDU session type or any access type.

(2) SSC Mode 2

If a PDU session of SSC mode 2 has a single PDU session anchor, the network may trigger release of the PDU session and may instruct the UE to establish a new PDU session in the same DN immediately. A trigger condition depends on an operator policy, for example, a request from an application function based on a load status. At establishment of the new PDU session, a new UPF device acting as the PDU session anchor may be selected.

On the contrary, if the PDU session of SSC mode 2 has the plurality of PDU session anchors (e.g., in the case of a multi-homed PDU session or if a UL CL applies to the PDU session of SSC mode 2), additional PDU session anchors may be released or allocated.

SSC mode 2 may apply to any PDU session type and any access type. In a UL CL mode, the UE may not be involved in PDU session anchor reallocation so that existence of the plurality of PDU session anchors is not visible to the UE.

(3) SSC Mode 3

With respect to a PDU session of SSC mode 3, the network allows establishment of UE connectivity through a new PDU session anchor in the same data network (DN) before connectivity between the UE and a previous PDU session anchor is released. If the trigger condition applies, the network may determine whether to select a PDU session anchor UPF suitable for the new condition of the UE (e.g., a point of attachment to the network).

SSC mode 3 may apply to any PDU session type or any access type.

With respect to a PDU session of IPv4 or IPv6 type, during a change procedure of the PDU session anchor, the following applies:

i) A new IP prefix anchored on the new PDU session anchor may be allocated within the same PDU session based on IPv6 multi-homing. ii) Alternatively, a new IP address or the new IP prefix may be allocated within the new PDU session that the UE is triggered to establish.

After the new IP address or the new IP prefix is allocated, an old IP address or an old IP prefix is maintained during a specific time indicated to the UE and then released.

If the PDU session of SSC mode 3 has the plurality of PDU session anchors (e.g., in the case of multi-homed PDU sessions, or if a UL CL applies to the PDU session of SSC mode 3, the additional PDU session anchors may be released or allocated.

<SSC Mode Selection>

An SSC mode selection policy is used to i) determine a type of a session or ii) determine a type of an SSC mode associated with an application or a group of applications for the UE.

An operator may provide the SSC mode selection policy to the UE. The SSC mode selection policy includes one or more SSC mode selection policy rules that may be used by the UE to determine the type of the SSC mode associated with the application or the group of applications. The SSC mode selection policy may include a default SSC mode selection policy rule that matches all applications of the UE.

When an application requests a data transmission (e.g., opens a network socket) and, here, the application does not specify a required SSC mode, the UE may select the SSC mode associated with the application based on the SSC mode selection policy. In addition, the following behaviors apply to the UE and the network:

a) If the UE already has an established PDU session that matches the SSC mode associated with the application, the UE may route data of the application within the established PDU session unless the UE permits the use of the established PDU session. On the contrary, if the UE does not have the established PDU session that matches the SSC mode associated with the application, the UE may request establishment of a new PDU session that matches the SSC mode associated with the application.

b) The SSC mode associated with the application is either an SSC mode included in a non-default SSC mode selection policy rule that matches the application or an SSC mode included in a default SSC mode selection policy rule, if present. If the SSC mode selection policy does not include the default mode selection policy rule and no other SSC mode selection policy rules match the application, the UE may request the PDU session without providing the SSC mode. In this case, the network may determine the SSC mode of the PDU session.

The SSC mode selection policy rule provided to the UE may be updated by the operator.

The SMF device may receive a list of SSC modes and a default SSC mode per DNN per S-NSSAI as a portion of subscription information from a unified data management (UDM) device.

If the UE provides an SSC mode when requesting a new PDU session, the SMF device may select the SSC mode by accepting the requested SSC mode or by modifying the requested SSC mode based on subscription and/or local configuration.

If the UE does not provide the SSC mode when requesting the new PDU session, the SMF device may select the default SSC mode for a data network listed in the subscription or may apply the local configuration to select the SSC mode.

When a static IP address/IP prefix is allocated to the PDU session, SSC mode 1 may be allocated to the PDU session based on static IP address/IP prefix subscription for the DNN and single network slice selection assistance information (S-NSSAI).

<Update on Location Reporting Based on Area of Interest>

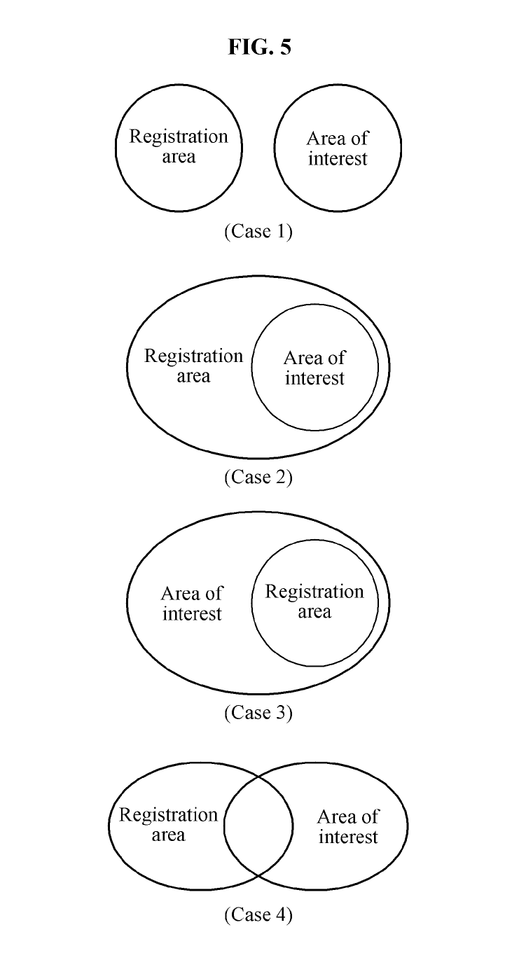

The condition, “if the AMF device subscribes to an area of interest through the SMF device and this area of interest is smaller than the registration area sent to the UE”, in the current text may describe cases that the registration area update (and Handover in CM-CONNECTED mode) is not enough to track the UE that moves in or out of the area of interest and thus, location reporting may be needed. However, the condition may not cover all the proper cases. FIG. 5 illustrates an example of four cases showing a relationship between a registration area and an area of interest according to an example embodiment. Although the location reporting may be required for all the cases, the location reporting may be required for, particularly, case 2 (in which the registration area includes the whole area of interest) and case 4 (in which the registration area has an intersection with some areas of interest, but does not include the whole registration area) among four cases.

<Session Management: UE Location Change Notification>

When a PDU session is established or modified, or when a user plane path is changed (e.g., UPF relocation), the SMF device may determine an area of interest, for example, based on a UPF service area, etc., and may subscribe to AMF notifications. When the AMF device detects that the UE moves in or out of the area of interest, the AMF device may need to notify the SMF device of a new location of the UE.

The SMF device subscribes to a “UE mobility event Notification” service provided from the AMF device. During subscription, the SMF device provides the area of interest to the AMF device. The AMF device sends the new location of the UE to the SMF device when the AMF device detects that the UE moves in or out of the area of interest.

In the case of a LADN, the SMF device provides the LADN DNN to the AMF device to subscribe to notifications when the UE enters or leaves the LADN service area. The AMF notifies the SMF when the AMF detects that the UE moves in or out of the LADN service area.

The subscription may be maintained during a lifetime of the PDU session, regardless of a UP activation state of the PDU session (e.g., whether the PDU session UP connection is activated).

In response to receiving a new UE location notification from the AMF device, the SMF device determines how to deal with the PDU session. For example, the SMF device determines whether to relocate a UPF, to release a PDU session, to deactivate a user plane connection for the PDU session, etc.

The SMF device may determine a new area of interest and may send a new subscription to the AMF device with the new area of interest. The SMF device unsubscribes from the “UE mobility event notification” service when the PDU session is released.

The UE location change notification may also be subscribed to by another NF.

<Support for Edge Computing)>

Edge computing enables the operator and 3rd party services to be hosted close to the UE's access point of attachment, to achieve an efficient service delivery through reduced end-to-end latency and load on a transport network.

The 5G core network selects a UPF device close to the UE and executes traffic steering from the UPF device to the local data network through an N6 interface. This may be performed based on the UE's subscription data, UE location, information from an application function, policies or other related traffic rules.

Due to user or application function mobility, the service or session continuity may be required based on the requirements of the service or the 5G core network. The 5G core network may expose network information and capabilities to an edge computing application function.

The functionality that supports edge computing may include the following: i) user plane (re)selection: the 5G core network (re)selects the UPF device to route the user traffic to the local data network; ii) local routing and traffic steering: the 5G core network selects the traffic to be routed to applications in the local data network, which includes the use of a single PDU session with multiple PDU session anchor(s) (UL CL/IP v6 multi-homing); iii) session and service continuity to enable UE and application mobility; iv) the application function may influence UPF (re)selection and traffic routing through PCF or NEF; v) network capability exposure: the 5G core network and the application function to provide information to each other through the NEF or directly; vi) QoS and charging: the PCF device provides rules for QoS control and charging for the traffic routed to the local data network; and vii) support of local area data network: the 5G Core Network provides support for connection to the LADN in a specific area in which the applications are deployed.

<Description of Network Functions: AMF Device>

The AMF device may perform the following functionalities. A portion or all of the functionalities of the AMF device may be supported in a single instance of the AMF device:

1) Termination of a RAN CP interface (N2); 2) termination of NAS (N1), NAS ciphering and integrity protection; 3) registration management; 4) connection management; 5) reachability management; 6) mobility management; 7) lawful intercept (for AMF device events and an interface to LI system); 8) sending of SM messages between the UE and the SMF device; 9) transparent proxy for routing SM messages; 10) access authentication; 11) access authorization; 12) sending of SMS messages between the UE and SMS function (SMSF); 13) security anchor functionality (SEAF) that interacts with the AUSF and the UE, receives an intermediate key established as a result of a UE authentication process, and enables the AMF device to retrieve a security material from the AUSF in the case of a USIM-based authentication; 14) security context management (SCM) that receives, from the SEAF, a key used to derive an access-network specific key; 15) location service management for regulatory services; 16) sending of location service messages between the UE and the LMF as well as between the RAN and the LMF; and 17) evolved packet system (EPS) bearer ID allocation for interworking with EPS.

Regardless of a number of network functions, a single NAS interface instance is present per access network between the UE and the CN and is terminated at one of the network functions that implement at least NAS security and mobility management.

In addition to the aforementioned functionalities of the AMF device, the AMF device may include the following functionalities to support a non-3GPP access network:

i) Support of an N2 interface with N3IWF: Through this interface, a portion of information (e.g., 3GPP cell identification) and procedures (e.g., a handover related procedure) defined over the 3GPP access may not be applied and non-3GPP access specific information that does not apply to the 3GPP access may be applied. ii) Support of NAS signaling with the UE over N3IWF: A portion of procedures supported by NAS signaling over the 3GPP access may not be applied to an untrusted non-3GPP (e.g., paging) access. iii) Support of authentication of UEs connected over N3IWF. iv) Management of mobility, authentication, and a separate security context state of the UE connected over the 3GPP access and or simultaneously connected over 3GPP access and the non-3GPP access. v) Support of a coordinated RM management context over the 3GPP access and the non-3GPP access. vi) Support of a dedicated CM management context for the UE for connectivity over the non-3GPP access.

<Description of Network Functions: SMF Device>

The SMF device may perform the following functionalities. A portion or all of the functionalities of the SMF device may be supported in a single instance of the SMF device:

i) The SMF device may perform a session management, for example, establishment, modification, and release of a session, including a tunnel maintained between the UPF device and an AN node. ii) The SMF device may perform a UE IP address allocation and management (optional authorization). iii) The SMF device may perform DHCPv4 (server and client) and DHCPv6 (server and client) functions. iv) The SMF device may perform ARP proxying specified in IETF RFC 1027 and/or IPv6 neighbor solicitation proxying specified in IETF RFC 4861 functionality for Ethernet PDUs. The SMF device may respond to the ARP and/or IPv6 neighbor solicitation request by providing a MAC address corresponding to an IP address sent in the request. v) The SMF device may perform a selection and a control of a UP function, including controlling the UPF device to a proxy ARP or IPv6 neighbor discovery, or to forward all of ARP/IPv6 neighbor solicitation traffic to the SMF device, for Ethernet PDU sessions. vi) The SMF device may configure traffic steering at the UPF device to route traffic to a proper destination. The SMF device may terminate interfaces towards policy control functions. The SMF device may perform lawful intercept (SM events and an interface to LI system). vii) The SMF device may perform charging data collection and support of charging interfaces. The SMF device may perform control and coordination of the charging data collection at the UPF device. The SMF device may perform termination of SM parts of NAS messages. The SMF device may perform a downlink data notification. The SMF device may be an initiator of AN specific SM information that is sent through the AMF device over N2 to the AN. The SMF device may determine an SSC mode of a session. viii) The SMF device may perform a roaming functionality, for example, (1) handling of local enforcement to apply QoS SLAs (VPLMN), (2) charging data collection and charging intercept (VPLMN), (3) lawful intercept (in VPLMN for SM events and the interface to LI system), and (4) support for interaction with an external DN for transport of signaling for PDU session authentication/authorization by the external DN.

Not all of the functionalities are required to be supported in an instance of a Network slice.

<Description of Network Functions: UPF Device>

The UPF device may perform the following functionalities. A portion or all of the functionalities of the UPF device may be supported in a single instance of the UPF device:

i) If applicable, the UPF device may perform a function of an anchor point for intra-/inter-RAT mobility. The UPF device may perform a function of an external PDU session point of interconnection to a data network. ii) The UPF device may perform packet routing and forwarding. For example, the UPF device may support a UP CL to route traffic flows to an instance of the data network and may support a branching point to support a multi-homed PDU session. iii) The UPF device may perform a packet inspection. For example, the UPF device may perform an application detection based on a service data flow template and optical PDFs additionally received from the SMF device. iv) The UPF device may perform a user plane part of policy rule enforcement, for example, grating, redirection, and traffic steering. The UPF device perform lawful intercept (UP collection). The UPF device may perform traffic usage reporting. The UPF device may perform QoS handling for a user plane, for example, UL/DL rate enforcement and reflective QoS marking in a DL. The UPF device may perform uplink traffic verification (SDF device to QoS flow mapping). The UPF device may perform datalink packet buffering and downlink data notification triggering. The UPF device may send and forward at least one “end marker” to a source NG-RAN node. v) The UPF device may perform ARP proxying specified in IETF RFC 1027 and/or IPv6 neighbor solicitation proxying specified in IETF RFC 4861 functionality for Ethernet PDUs. The UPF device may respond to an ARP and/or IPv6 neighbor solicitation request by providing a MAC address corresponding to an IP address sent in the request.

Not all of the UPF functionalities are required to be supported in an instance of a user plane function of a network slice.

<Description of Network Functions: PCF Device>

The policy control function (PCF) device includes the following functionality of: i) supporting a unified policy framework to govern a network behavior; ii) providing policy rules to control plane function(s) to enforce the policy rules; and iii) implementing a PCF front end (PCF FE) to access subscription information relevant for policy decisions in a unified data repository (UDR). For reference, the PCF device may access a UDR located in the same PLMN as the PCF device.

<SMF Selection Function>

The SMF selection function is supported by the AMF device and is used to allocate an SMF device that may manage a PDU session.

The SMF selection function in the AMF device may utilize a network repository function (NRF) to discover SMF instance(s) unless SMF information is available by other methods, for example, locally configured on the AMF device. The NRF provides an IP address or an FQDN of the SMF instance(s) to the AMF device.

The SMF selection function in the AMF device is applicable to both the 3GPP access and the non-3GPP access.

The following factors may be considered during the SMF selection: i) selected data network name (DNN); ii) S-NSSAI; iii) subscription information from UDM (e.g, per DNN: whether LBO roaming is allowed, per S-NSSAI: the subscribed DNN(s), per (S-NSSAI, subscribed DNN): whether LBO roaming is allowed; iv) local operator policies; and v) load conditions of candidate SMF devices.

If there is an existing PDU session for the UE to the same DNN and S-NSSAI used to derive the SMF device, the same SMF device may be selected. However, a different SMF device may be selected, for example, to support a SMF load balancing or to support a graceful SMF shutdown (e.g., the SMF device starts to no more take new PDU sessions).

In a home-routed roaming case, the SMF selection function selects an SMF device in a VPLMN as well as an SMF device in an HPLMN.

If the UDM provides a DN subscription context that allows for handling the PDU session in a visited PLMN (i.e., using LBO) for this DNN and, optionally, the AMF device is configured to know that the visited VPLMN has a suitable roaming agreement with the HPLMN of the UE, the SMF selection function selects an SMF device from the visited PLMN. If the SMF device in the VPLMN may not be derived for the DNN and a network slice, or if the subscription does not allow for handling the PDU session in the visited PLMN using LBO, both the SMF device in the VPLMN and the SMF device in the HPLMN may be selected and the DNN may be used to derive an SMF identifier from the HPLMN.

If the initially selected SMF device in the VPLMN (for roaming with LBO) detects that it does not understand information in the UE request, it may reject the N11 message (related with a PDU session establishment request) with a proper N11 cause triggering the AMF device to select both a new SMF device in the VPLMN and an SMF device in the HPLMN (for home routed roaming).

<AMF Selection>

The AMF selection functionality is applicable to both the 3GPP access and the non-3GPP access. The AMF selection functionality may be supported by the 5G-AN (e.g., RAN and N3IWF) and is used to select an AMF device for a given UE. The AMF device supports the AMF selection functionality to select an AMF device for relocation or because the initially selected AMF is inappropriate to serve the UE (e.g., due to a change of allowed NSSAI). Other CP NF(s), for example, the SMF device, supports the AMF selection functionality to select an AMF device from the AMF set when the original AMF device serving the UE is unavailable.

The 5G AN selects an AMF set and an AMF device from the AMF set under the following circumstances: 1) when the UE provides no 5G-S-TMSI nor the GUAMI to the 5G-AN; 2) when the UE provides 5G-S-TMSI or GUAMI but routing information (i.e., AMF device identified based on AMF set ID, AMF pointer) present in the 5G-S-TMSI or GUAMI is insufficient and/or unusable (e.g., the UE provides 5G-S-TMSI with an AMF region ID from a different region); and 3) when the AMF device informs the AN that the AMF device (identified by GUAMI(s)) is unavailable and no target AMF device is identified and/or the AN detects failure of the AMF device.

Other CP NFs select the AMF device from the AMF set under the following circumstances: 4) when the AMF device informs the AN that a specific AMF device identified by GUAMI(s) is unavailable and the CP NF is not notified of the target AMF device, and/or CP NF detects the failure of the AMF device.

The AMF selection functionality in the 5G-AN may consider the following factors for selecting the AMF set: i) requested NSSAI; and ii) local operator policies.

The AMF selection functionality in the 5G AN or CP NFs may consider the following factors for selecting an AMF device from the AMF set: i) availability of candidate AMF devices; and ii) load balancing across candidate AMF devices (e.g., considering weight factors of candidate AMF devices in the AMF set).

When 5G-S-TMSI or GUAMI that is provided from the UE to the 5G-AN includes an AMF set ID that is usable and an AMF device identified by an AMF pointer that is not usable (e.g., the AN detects the failure of the AMF device) or when the corresponding AMF device indicates that the AMF device is unavailable (e.g., out of operation), the 5G-AN may use the AMF set ID for selecting another AMF device from the AMF set based on the aforementioned factors.

The AMF selection functionality in the AMF device or other CP NFs may utilize the NRF to discover the AMF instance(s) unless AMF information is available by other methods, for example, locally configured on the AMF device or other CP NFs. The NRF provides an IP address or a FQDN of AMF instance(s) to the AMF device or other CP NFs. i) The AMF selection functionality in the AMF device or other CP NFs may use the GUAMI to discover the AMF instance, and the NRF may provide the IP address or the FQDN of the AMF instance, or a list of candidate AMF instances in the same AMF set together with additional information (e.g., priority) if the indicated GUAMI may not be found. ii) The AMF selection functionality in the AMF device may use AMF set ID to discover the AMF instance(s) and the NRF may provide a list of AMF instances in the same AMF set together with additional information (e.g., priority).

<Registration Management Procedures>

The UE needs to register with the network to get authorized to receive services, to enable mobility tracking and to enable reachability.

The registration procedure may be used when the UE needs to perform an initial registration to the 5GS and to perform a mobility registration update in response to changing to a new tracking area (TA) outside a registration area of the UE in both a CM_CONNECTED mode and a CM_IDLE mode, when the UE performs a periodic registration update (due to a predefined time period of inactivity), and additionally when the UE needs to update capabilities or protocol parameters of the UE that are negotiated in the registration procedure.

Although the following general registration call flow may apply to all the registration procedures, the periodic registration may have no need to include all parameters that are used in other registration cases.

Also, the general registration call flow may be used for an emergency registration by UEs that require to perform emergency services but may not gain normal services from the network. The UEs may be in a limited service state as defined in TS 23.122.

During the initial registration, a peripheral equipment interface (PEI) may be obtained from the UE. An AMF operator may verify the PEI with an equipment identity register (EIR). The AMF device may pass the PEI (IMEISV) to the UDM, to the SMF device, and the PCF device. The DUM device may store the data by Nudr_SDM_Update.

<Deregistration Procedures>

The deregistration procedure allows: i) the UE to inform the network that the UE does not desire to access the 5GS any longer; and ii) the network to inform the UE that the network does not have access to the 5GS any longer.

A deregistration request from the UE and the network includes whether the deregistration applies to the 3GPP access, the non-3GPP access, or both the 3GPP access and the non-3GPP access. When the UE is registered to both the 3GPP access and the non-3GPP access in the same PLMN, a deregistration message may be sent to any of the 3GPP access and the non-3GPP access regardless of an access to which the deregistration is applied.

<Session Management Procedure: PDU Session Establishment>

The PDU session establishments may correspond to: i) a UE initiated PDU session establishment procedure; and ii) a network triggered PDU session establishment procedure. In this case, the network may send a device trigger message to application(s) on a UE side. A payload included in a device trigger request message may include information regarding which application on the UE side is expected to trigger the PDU session establishment request. Based on the information, the application(s) on the UE side may trigger the PDU session establishment procedure.

If the UE is simultaneously registered to the non-3GPP access through a N3IWF located in a PLMN different from a PLMN of the 3GPP access, functional entities in the following procedure may be located in the PLMN of the access used to exchange NAS with the UE for the PDU session.

<Session Management Procedure: PDU Session Modification>

The PDU session modification procedure is used when at least one of QoS parameters exchanged between the UE and the network is modified.

<Session Management Procedure: PDU Session Release >

The PDU session release procedure is used to release all the resources associated with a PDU session, including i) IP address/prefixes allocated for an IP-based PDU session that may include release of multiple prefixes in the case of multi-homing; and ii) any UPF resource (including N3/N9 termination) that is used by the PDU session.

The SMF device may desire to notify any entity associated with the PDU session, such as, for example, the PCF device and the DN (e.g., when DN authorization occurs at PDU session establishment), etc., of PDU session release.

<N4 Session Management Procedures>

The N4 session management procedures are used to control the functionality of the UPF device. The SMF device may create, update, and remove an N4 session context in the UPF device. The N4 session management procedures, that is, N4 session establishment procedure, N4 session modification procedure, and N4 session release procedure, are initiated by the SMF device:

1. N4 Session Establishment Procedure

The N4 session establishment procedure is used to create an initial N4 session context for a PDU session at the UPF device. The SMF device assigns a new N4 session ID and provides the assigned new N4 session ID to the UPF device. The N4 session ID is stored in the SMF device and the UPF device and used to identify the N4 session context during an interaction between the SMF device and the UPF device. Also, the SMF device stores a relationship between the N4 session ID and the PDU session for the UE.

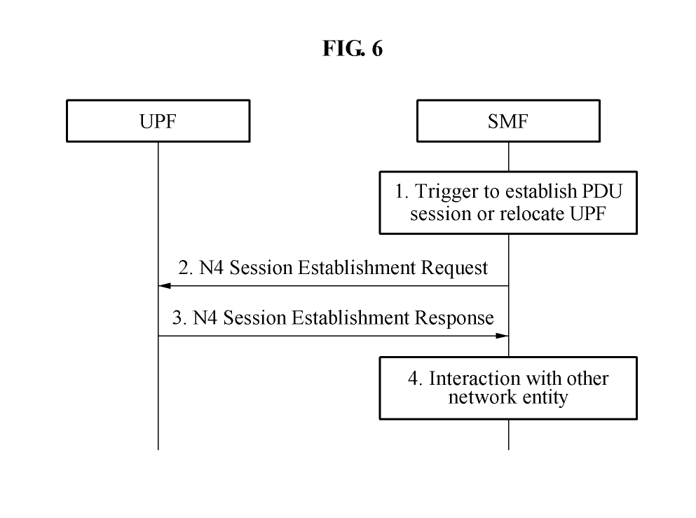

FIG. 6 illustrates an example of the N4 session establishment procedure according to an example embodiment.

Referring to FIG. 6, in operation 1, the SMF device may receive a trigger to establish a new PDU session or change, for example, relocate the UPF device for an established PDU session.

In operation 2, the SMF device may send an N4 session establishment request message to the UPF device, including structured control information used to define how the UPF device needs to behave.

In operation 3, the UPF device may respond with an N4 session establishment response message including information that the UPF device needs to provide to the SMF device in response to the received control information.

In operation 4, the SMF device may interact with a network entity that triggers the N4 session establishment procedure.

2. N4 Session Modification Procedure

The N4 session modification procedure is used to update an N4 session context of an existing PDU session at the UPF device, which is executed between the SMF device and the UPF device every time PDU session related parameters need to be modified.

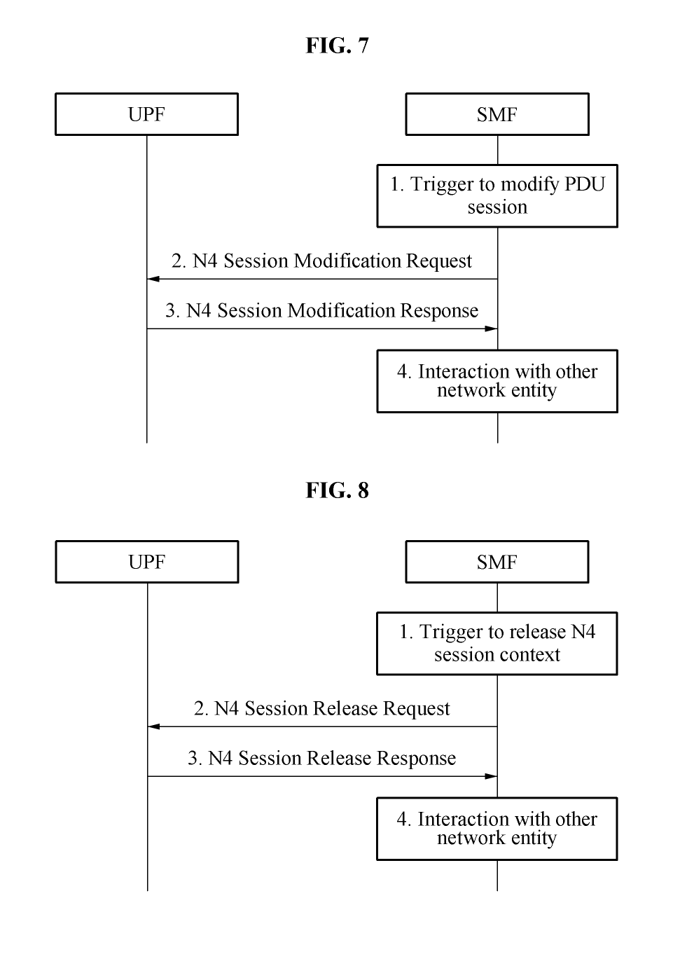

FIG. 7 illustrates an example of the N4 session modification procedure according to an example embodiment.

Referring to FIG. 7, in operation 1, the SMF device may receive a trigger to modify the existing PDU session.

In operation 2, the SMF device may send an N4 session modification request message to the UPF device, including update for structured control information used to define how the UPF device needs to behave.

In operation 3, the UPF device may identify the N4 session context to be modified based on an N4 session ID and may update parameters of the N4 session context based on a list of parameters sent from the SMF device. The UPF device responds with an N4 session modification response message including information that the UPF device needs to provide to the SMF device in response to the received control information.

In operation 4, the SMF device may interact with a network entity (e.g., AMF or PCF) that triggers the N4 session modification procedure.

3. N4 Session Release Procedure

The N4 session release procedure is used to remove an N4 session context of an existing PDU session at the UPF device.

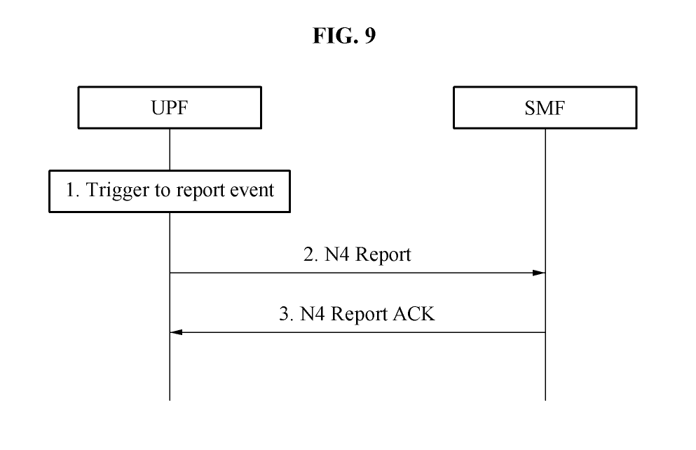

FIG. 8 illustrates an example of the N4 session release procedure according to an example embodiment.

Referring to FIG. 8, in operation 1, the SMF device may receive a trigger to release an N4 session context for the existing PDU session.

In operation 2, the SMF device may send an N4 session release request message to the UPF device.

In operation 3, the UPF device may identify the N4 session context to be removed based on an N4 session ID and may remove the entire session context. The UPF device responds with an N4 release response message including information that the UPF device needs to provide to the SMF device.

In operation 4, the SMF device may interact with a network entity (e.g., AMF or PCF) that triggers the N4 session release procedure.

<N4 Reporting Procedures)>

FIG. 9 illustrates an N4 reporting procedure according to an example embodiment.

The N4 reporting procedure is used by a UPF device to report events related to an N4 session for an individual PDU session. A trigger for event reporting is configured on the UPF device during N4 session establishment/modification procedures by an SMF device.

Referring to FIG. 9, in operation 1, the UPF device may detect an event that needs to be reported. The reporting trigger may include the following cases:

(1) Usage Report

Usage information may be collected by the UPF device and reported to the SMF device.

(2) Start of Traffic Detection

When traffic detection is requested by the SMF device and a start of traffic is detected for a packet detection rule (PDR), the UPF device may report the start of traffic detection to the SMF device and may indicate a corresponding PDR ID.

(3) Stop of Traffic Detection

When traffic detection is requested by the SMF device and an end of traffic is detected for the PDR, the UPF device may report the stop of traffic detection to the SMF device and may indicate a corresponding PDR ID.

(4) Detection of First Downlink Data for UE in CM-IDLE State

When the UPF device receives a downlink packet, no N3/N9 tunnel for downlink data transmission is present, and buffering is performed by the UPF device, the UPF device may report the detection of first downlink data to the SMF device for the purpose of downlink data notification. The UPF device may also report DSCP of a packet in response to an instruction from the SMF device.

In operation 2, the UPF device may send an N4 report message (N4 session ID, list of [reporting trigger, measurement information]) to the SMF device.

Here, the reporting trigger parameter may include a name of an event that triggers the report and the measurement information parameter may include actual information requested by the SMF device.

In operation 3, the SMF device may identify an N4 session context based on the received N4 session ID and may apply the reported information to a corresponding PDU session. The SMF device responds with an N4 report ACK message.

<Change of SSC Mode 2 PDU Session Anchor with Different PDU Sessions>

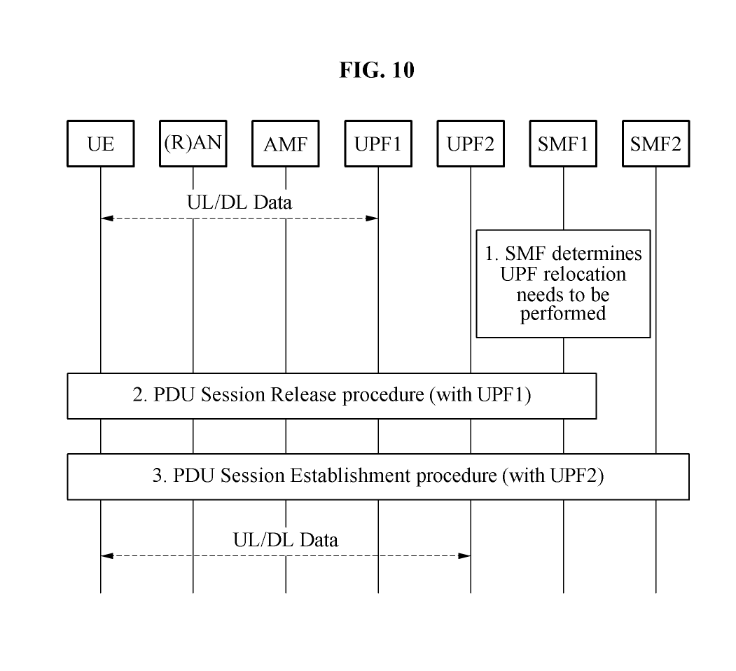

FIG. 10 illustrates an example of a change procedure of SSC mode 2 PSA for a PDU session according to an example embodiment.

FIG. 10 illustrates an example of a procedure that is triggered by an SMF device to change a PDU session anchor serving a PDU session of SSC mode 2 for a UE when neither multi-homing nor UL CL applies to the PDU session. The procedure may release the existing PDU session associated with an old PDU session anchor (UPF1 of FIG. 10) and immediately establish a new PDU session with a new PDU session anchor (UPF2).

Referring to FIG. 10, in operation 1, the SMF device may determine that a serving UPF device needs to be changed due to events that may benefit from such change.

In operation 2, the PDU session release procedure with the old PDU session anchor may be initiated. The SMF device may send N1 SM information to the UE through an AMF device by invoking Namf_Communication_N1N2MessageTransfer. A PDU session release command message in the N1 SM information may include a PDU session ID and a cause indicating that a PDU session re-establishment in the same DN is required.

In operation 3, in response to receiving the PDU session release command with the cause indicating that the PDU session re-establishment in the same DN is required, the UE may create a new PDU session ID and may initiate a PDU session establishment procedure. The AMF device may select an SMF device and the SMF device may select a new UPF (i.e., UPF2) device for the re-established PDU session of SSC mode 2.

<Change of SSC Mode 3 PDU Session Anchor with Plurality of PDU Sessions>

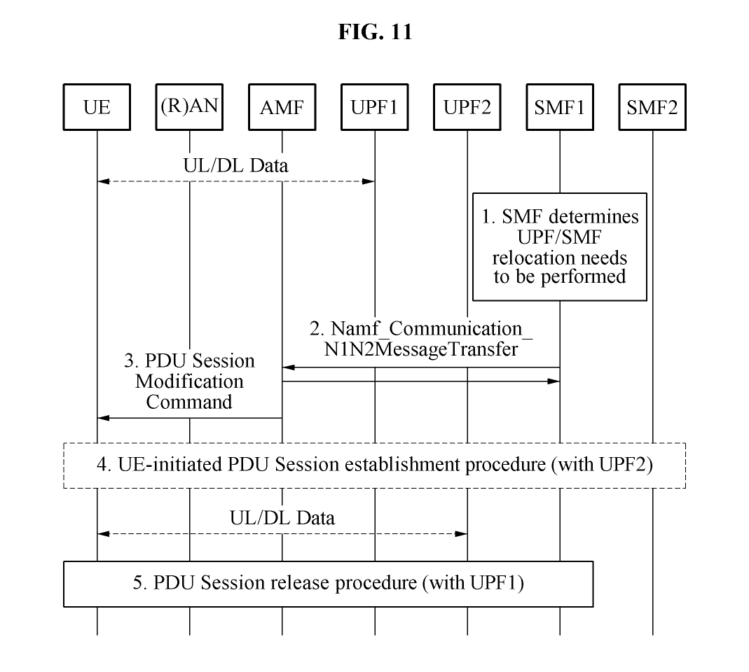

FIG. 11 illustrates an example of a change procedure of SSC mode 3 PDU session anchor with the plurality of PDU sessions according to an example embodiment.

FIG. 11 illustrates an example of a procedure that is triggered by an SMF device to change a PDU session anchor serving a PDU session of SSC mode 3 for a UE. This procedure may release an existing PDU session associated with an old PDU session anchor (UPF1 of FIG. 11) after establishing a new PDU session in the same DN with a new PDU session anchor (UPF2), which is controlled by the same SMF device. The SMF device may determine that a new SMF device needs to be reallocated.

Referring to FIG. 11, in operation 1, the SMF device may determine that the serving UPF device or the SMF device needs to be changed.

In operation 2, the SMF device may invoke Namf_Communication_N1N2MessageTransfer (PDU session ID, SMF reallocation requested indication, N1 SM container (PDU session modification command (cause, PDU session release timer)). Here, the PDU session ID indicates the existing PDU session to be relocated and the cause indicates that a PDU session re-establishment in the same DN is required.

The SMF reallocation requested indication indicates whether the SMF device is requested to be reallocated. A release timer value indicates an amount of time during which the network is willing to maintain the PDU session.

In operation 3, the AMF device may forward a NAS message to the UE.

In operation 4, if the UE receives the PDU session modification command, the UE may determine to initiate a PDU session establishment procedure.

In an SSC mode, the UE may create a new PDU session ID and initiate a PDU session establishment request using the new PDU session ID. The new PDU session ID may be included as a PDU session ID in a NAS request message. The old PDU session ID indicates that the existing PDU session to be released may also be provided to the AMF device in the NAS request message.

If the SMF device reallocation is requested in operation 2, the AMF device may select a different SMF device. Otherwise, the AMF device may send an N11 message to the same SMF device serving the old PDU session ID.

The AMF device may include both the PDU session ID and the old PDU session ID in an Nsmf_PDUSession_CreateSMContext request. The SMF device may detect that the PDU session establishment request is related to the trigger in operation 2 based on the presence of the old PDU session ID in the Nsmf_PDUSession_CreateSMContext request. The SMF device may store the new PDU session ID and may select a new PDU session anchor (i.e., UPF2) for the new PDU session.

In operation 5, the old PDU session may be released by the UE before the timer provided in operation 1 expires (e.g., once the UE consolidates all traffic on PDU#2 or if the session is no more needed) or by the SMF device upon expiry of this timer.

<UE Configuration Update>

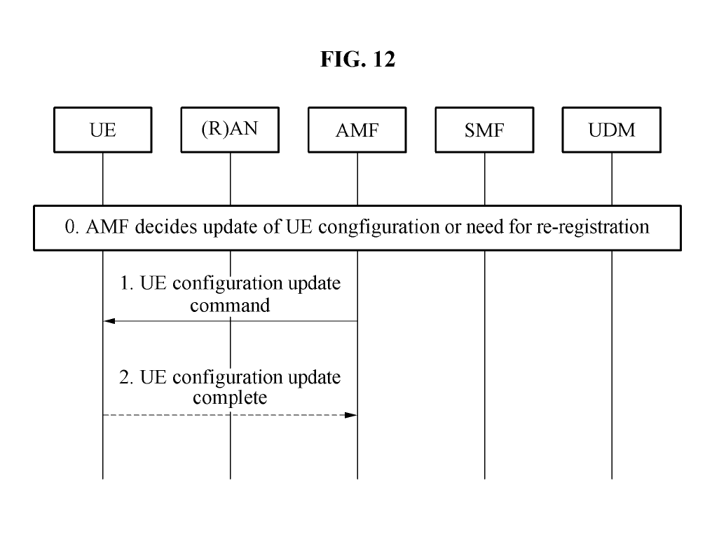

FIG. 12 illustrates an example of a UE configuration update procedure according to an example embodiment.

The UE configuration procedure is used when an AMF device desires to change a UE configuration. The UE configuration procedure applies only to information in a UE that does not require negotiation between the UE and a network.

The UE configuration procedure is also used to trigger a UE registration update procedure to modify parameters that require negotiation (e.g., MICO mode) or to request the UE to perform a registration update procedure (e.g., for a change to allowed NSSAI that require re-registration).

If the AMF device desires to update NAS parameters in the UE that require UE acknowledgement, the AMF device provides an indication to the UE regarding whether the UE may acknowledge a command. The AMF device may not request acknowledgement of the NITZ command. The AMF device may request acknowledgement for NSSAI information (e.g., allowed NSSAI), 5G-GUTI, TAI list, and mobility restrictions.

Referring to FIG. 12, in operation 0, the AMF device may determine necessity of a UE configuration change due to various reasons (e.g., UE mobility change, NW policy, UE subscription change) or may determine that the UE needs to perform a registration procedure. If the UE is in a CM-IDLE state, the AMF device triggers a network triggered service request.

The AMF device may include a handover restriction list in an N2 message that delivers a UE configuration update command to the UE if a service area restriction for the UE is updated.

In operation 1, the AMF device may send the UE configuration update command including UE parameters (5G-GUTI, TAI list, allowed NSSAI, network identity and time zone (NITZ), mobility restrictions, LADN information, UE configuration update cause) to the UE.

The AMF device may include at least one of the 5G-GUTI, the TAI list, the allowed NSSAI, the NITZ, mobility restrictions parameters, and the LADN information if the AMF device desires to update NAS parameters without triggering the UE re-registration.

Also, the AMF device may include, in the UE configuration update command, the UE configuration update cause indicating whether the UE may acknowledge the command or, if the command is sent to trigger re-registration, including a registration update request parameter, which indicates a cause for the re-registration and related information about a UE behavior (e.g., wait for a CM-IDLE state to perform re-registration).

In operation 2, if the UE configuration update cause requires acknowledgement of the UE configuration update command, the UE may send a UE configuration update complete message to the AMF device. The AMF device may need to request acknowledgement for all UE configuration updates, except for the NITZ.

Here, when receiving the UE configuration update command without the cause indicating the need to perform re-registration, it may trigger the UE to perform the registration update procedure for other reasons.

<Reachability Procedures>

Elements of the reachability procedure are used by both “SMS over NAS” and UDM initiated UE reachability notification requests.

The reachability procedure applies to UEs that are in an RRC idle state, an RRC inactive state, and an RRC connected state.

The following two procedures may be necessary for any service related entity that needs to be notified by reachability of a UE: i) a UE reachability notification request procedure; and ii) a UE activity notification procedure.

1. UE Reachability Notification Request Procedure

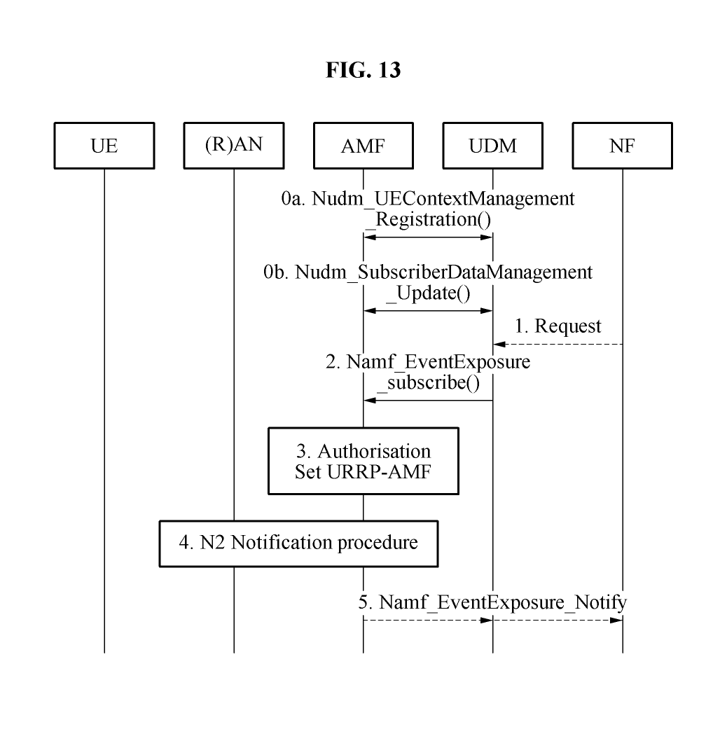

FIG. 13 illustrates an example of a UE reachability notification request procedure according to an example embodiment.

Referring to FIG. 13, in operation 0, during a registration or subscription update procedure, a UDM may inform an AMF device of identities (e.g., FQDNs) of network functions that are authorized to request notifications on a UE reachability through a Nudm_UEContextManagement_Registration or Nudm_SubscriberData_Update service operation. By default, the UDM may be authorized at all times.

In operation 1, if a service-related entity requests the UDM to provide an indication regarding the UE reachability, the UDM may verify that the corresponding entity is authorized to perform a corresponding request on a corresponding subscriber.

If the entity is not authorized, the request may be rejected (e.g., if the requesting entity is recognized as being a valid entity, but not authorized for the subscriber) or implicitly discarded (e.g., if the requesting entity is not recognized).

In operation 2, the UDM may store an identity of the service-related entity and may set a URRP-AMF parameter to indicate that such request is received. If a value of the URRP-AMF parameter changes from “not set” to “set”, the UDM may initiate a Namf_EventExposure_Subscribe service operation (URRP-AMF) towards the AMF device. The UDM may indicate if a direct notification to an NF may be used.

In operation 3, the AMF device may verify that the requesting entity is authorized to perform a corresponding request on a corresponding subscriber.

If the entity is not authorized, the request may be rejected (e.g., if the requesting entity is recognized as being a valid entity, but not authorized for the subscriber) or implicitly discarded (e.g., if the requesting entity is not recognized).

If the AMF device has an MM context for a corresponding user, the AMF device may set URRP-AMF to indicate a need to report UDM information about the change in the UE reachability (e.g., when a next NAS activity with the UE is detected).

In operation 4, if the UE in the AMF device is in a CM-CONNECTED state, the AMF device may initiate an N2 notification procedure in which a reporting type is set to a single RRC connected state notification.

In operation 5, when the UE reachability is present, the AMF device may initiate a UE reachability notification using Namf_EventExposure_Notify (SUPI, UE-reachable) towards either the UDM or using the direct notification to the NF. The AMF device may clear the corresponding URRP-AMF for the UE.

For the UE in a CM-IDLE state, the UE reachability is present at a next NAS signaling UE activity. For the UE in the CM-CONNECTED state, the UE reachability is present either when the AMF device receives a UE notification from an (R)AN node informing that the UE is reachable, or when the AMF device receives a path switch request from a new RAN node.

2. UE Activity Notification Procedure

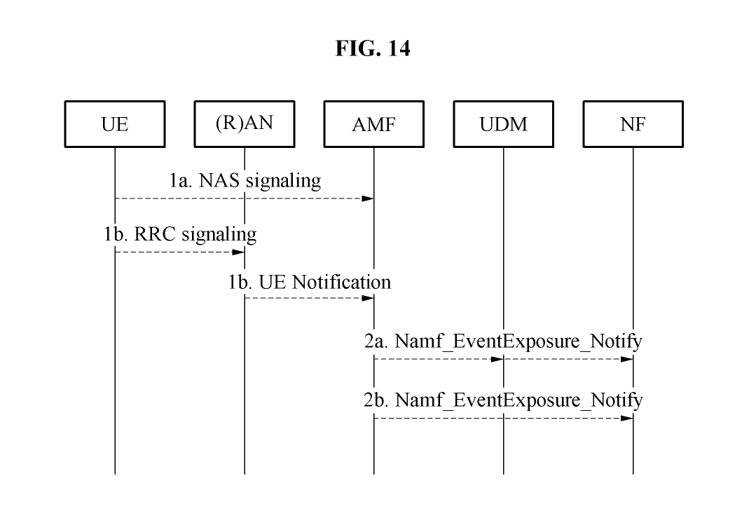

FIG. 14 illustrates an example of a UE activity notification procedure according to an example embodiment.

Referring to FIG. 14, in operation 1a, an AMF device may receive, from a UE, an (N1) NAS signaling implying a UE reachability (e.g., a registration request message or a service request message).

Alternatively, in operation 1b, the AMF device may receive an (N2) UE notification or a (N2) path switch request from a (R)AN.

In operation 2a, if the AMF device has an MM context for the UE and a URRP-AMF is set to report that the UE is reachable, the AMF device may initiate an Namf_EventExposure_Notify service operation (SUPI, UE-reachable) message to a UDM or directly to an NF. The AMF device may clear the corresponding URRP-AMF for the UE.

In operation 2b, when the UDM receives the Namf_EventExposure_Notify service operation (SUPI, UE-reachable) message or a Nudm_UEContextManagement_Registration service for the UE that has the URRP-AMF set, it triggers appropriate notifications to NFs (e.g., SMSF or SMS-GMSC) that subscribe to the UDM for this notification. The UDM may clear the URRP-AMF for the UE.

<User Profile Management Procedures: Subscriber Data Update Notification to AMF Device>

Whenever a user profile is changed for a user in the UDM and the change affects the user profile in the AMF device, the UDM may notify the change to the affected AMF device by invoking a Nudm_SubscriberDataManagement_UpdateNotification service operation. The AMF device adds or modifies the user profile.

The Nudm_SubscriberDataManagement_UpdateNotification service operation is used by the UDM to update subscriber data stored in the AMF device.

The AMF device initiates an appropriate action based on the changed subscriber data, for example, including: i) initiating an AMF initiated deregistration procedure if the updated subscription data indicates that the UE is not allowed to roam in this network; and ii) updating a UE context stored at an AN to modify the subscribed UE-AMBR.

<Location Reporting Procedures>

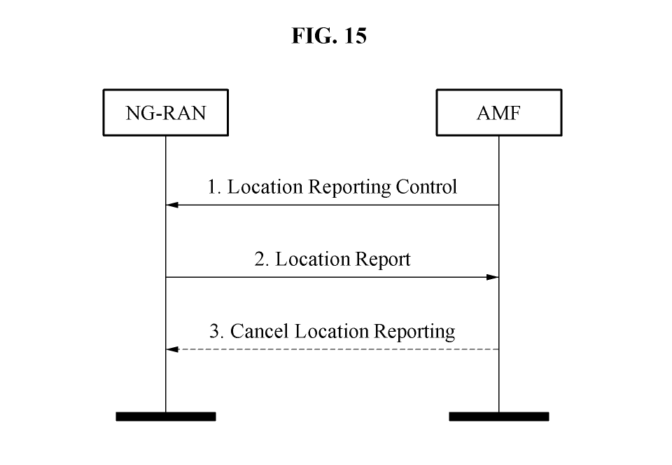

FIG. 15 illustrates an example of a location reporting procedure according to an example embodiment.

The location reporting procedure is used by an AMF device to request an NG-RAN to report where a UE is currently located when a target UE is in a CM-CONNECTED state. A need for the NG-RAN to continue reporting is stopped when the UE transitions to a CM-IDLE state or the AMF device sends a cancel indication. The location reporting procedure may be used for services that require accurate cell identification (e.g., emergency services, lawful intercept, charging), or for subscription to a service by other NFs.

Referring to FIG. 15, in operation 1, the AMF device may send a location reporting control message to the NG-RAN. The location reporting control message may identify the UE for which reports are requested, requested location information, and a reporting type. The requested location information may be represented by TAI+ cell identity. The reporting type indicates whether the location reporting control message is intended to trigger a single standalone report about a current cell identity that serves the UE, to start the RAN to report whenever the UE changes a cell, or to request the NG-RAN to report whenever the UE moves in or out of an area of interest. If the reporting type indicates to start the NG-RAN to report when the UE moves in or out of the area of interest, the AMF device also provides information about the requested area of interest (i.e., list of TAI) in the location reporting control message.

In operation 2, the RAN may send a location report message informing the AMF device about a location of the UE that may include the requested location information. When the UE is in a CM-CONNECTED state with an RRC inactive state, if the RAN receives the location reporting control message from the AMF device with the reporting type indicating the single standalone report, the RAN may perform RAN paging before reporting the location to the AMF device. When the UE is in the CM-CONNECTED state with the RRC inactive state, if the RAN receives the location reporting control message from the AMF device with the reporting type indicating continuously reporting whenever the UE changes the cell, the RAN may send the location report message to the AMF device including a last known location of the UE with a timestamp. If the reporting type indicates to start the NG-RAN to report when the UE moves in or out of the area of interest, the NG-RAN may send the location report message to the AMF device with the location of the UE when the NG-RAN recognizes that the UE moves in or out of the area of interest.

In operation 3, the AMF device may send a cancel location reporting message to inform the RAN that the AMF device needs to terminate location reporting for a given UE. The cancel location reporting message is needed only when the reporting is requested for a reporting period. Here, although new control signaling is not transferred during an active handover, location reporting is transferred during Xn handover.

The components described in the example embodiments may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the example embodiments may be achieved by software, and the software may be recorded on a recording medium. The components, the functions, and the processes described in the example embodiments may be achieved by a combination of hardware and software.

The systems and/apparatuses described herein may be implemented using hardware components, software components, and/or combination thereof. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include a plurality of processing elements and a plurality of types of processing elements. For example, a processing device may include a plurality of processors or a processor and a controller. In addition, different processing configurations are possible, such as parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

The components described in the example embodiments may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the example embodiments may be achieved by software, and the software may be recorded on a recording medium. The components, the functions, and the processes described in the example embodiments may be achieved by a combination of hardware and software.

A number of example embodiments have been described above. Nevertheless, it needs to be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A location reporting method performed by an access and mobility management function (AMF) device, the method comprising:
sending a location reporting control message requesting a location of a user equipment (UE) to an access network; and
receiving a location report message from the access network in response to the location reporting control message,
wherein the location reporting control message includes requested location information or a reporting type.

2. The method of claim 1, wherein the requested location information is a tracking area identifier (TAI) and a cell identity (ID).

3. The method of claim 1, wherein the reporting type indicates whether the location reporting control message is to trigger a single standalone report about a current cell identity that services the UE, to start the access network to report whenever the UE changes a cell, or to request the access network to report whenever the UE moves in or out of an area of interest.

4. The method of claim 3, further comprising:
providing information about the area of interest requested through the location reporting control message when the reporting type is to request the access network to report whenever the UE moves in or out of the area of interest.

5. The method of claim 1, further comprising:
sending a cancel location reporting message to the access network.

6. The method of claim 5, wherein the cancel location reporting message indicates a termination of location reporting for the UE.

7. The method of claim 5, wherein the cancel location reporting message is sent in response to a request for the location reporting for a desired period of time.

8. The method of claim 3, wherein, when the location reporting control message is to trigger the single standalone report and the UE is in a CM-CONNECTED state with a radio resource control (RRC) inactive state, the access network is configured to perform radio access network (RAN) paging before reporting a location to the AMF device.

9. The method of claim 3, wherein, when the location reporting control message is to start the access network to continuously report whenever the UE changes the cell and the UE is in a CM-CONNECTED state with an RRC inactive state, the AMF device is configured to receive, from the access network, the location report message including a last known location of the UE with a timestamp.

10. The method of claim 3, wherein the reporting type indicates that the location reporting control message is to request the access network to report whenever the UE moves in or out of the area of interest, the AMF device is configured to receive the location report message including the location of the UE in response to the access network recognizing that the UE moves in or out of the area of interest.

11. A user equipment (UE) location change notification method performed by a session management function (SMF) device, the method comprising:
determining an area of interest and providing the determined area of interest to an access and mobility management function (AMF) device; and
receiving a new location of a UE from the AMF device based on whether the UE moves in or out of the area of interest,
wherein the area of interest is determined based on a user plane function (UPF) service area.

12. The method of claim 11, wherein the SMF device is configured to subscribe to a UE mobility event notification service provided from the AMF device, and
the service subscription is maintained during a lifetime of a protocol data unit (PDU) session.

13. The method of claim 11, wherein the SMF device relocates a UPF device, releases a PDU session, or deactivates a user plane connection for the PDU session, in response to receiving a new location of the UE.

14. The method of claim 13, wherein the SMF device is configured to determine a new area of interest corresponding to the new location of the UE.

15. The method of claim 12, wherein the SMF device is configured to unsubscribe from the UE mobility event notification service in response to releasing the PDU session.

16. A user equipment (UE) location change notification method performed by an access and mobility management function (AMF) device, the method comprising:
verifying whether a UE moves in or out of an area of interest; and
notifying a session management function (SMF) device of a new location of the UE,
wherein the area of interest is determined based on a user plane function (UPF) service area.

17. The method of claim 16, wherein the SMF device is configured to subscribe to a UE mobility event notification service provided from the AMF device, and
the SMF device is configured to determine the area of interest and to provide the determined area of interest to the AMF device during the service subscription.

18. The method of claim 16, wherein the service subscription is maintained during a lifetime of a protocol data unit (PDU) session.
